(19) United States
(12) Patent Application Publication
(10) Pub. No.: US 2004/0225998 A1
(43) Pub. Date: Nov. 11, 2004

(54) Undo/Redo technique with computed of line information in a token-oriented representation of program code

(75) Inventors: Michael L. Van De Vanter, Mountain View, CA (US); Kenneth B. Urquhart, Bellevue, WA (US)

Correspondence Address: ZAGORIN O'BRIEN & GRAHAM, L.L.P., 7600B N. CAPITAL OF TEXAS HWY., SUITE 350, AUSTIN, TX, 78731, US

(73) Assignee: Sun Microsystems, Inc.

(21) Appl. No.: 10/430,539

(22) Filed: May 6, 2003

(51) Int. Cl. G06F 9/44

(52) U.S. Cl. 717/113; 717/109

(57) ABSTRACT

An editor, software engineering tool or collection of such tools may be configured to encode (or employ an encoding of) an insertion point representation that identifies a particular token of a token-oriented representation and offset thereinto, together with at least some line-oriented coordinates. Such a tool (or tools) may be further configured to maintain, coincident with an operation that modifies contents of the token-oriented representation, an undo object that identifies pre-modification line demarcation state. Often, the pre-modification state also includes both a token coordinates and a line-coordinates representation of the insertion point and storage of pre-modification state in, or in association with, the undo object facilitates efficient implementation of a undo operation, e.g., generally without recomputation of a coordinate representation or line demarcation state, which would otherwise scale with buffer size. In this way, lexical tokens corresponding to an inserted substring can be readily and efficiently excised to restore a pre-insertion tokenized list and insertion point state. Similarly, lexical tokens corresponding to a removed substring can be readily and efficiently reinstated to restore a pre-deletion tokenized list and insertion point state.

### CROSS-REFERENCE TO RELATED APPLICATION(S)

This application is related to commonly-owned U.S. patent application Ser. Nos. 10/185,752, 10/185,753, 10/185,754 and 10/185,761, each naming Van De Vanter and Urquhart as inventors and each filed on Jun. 28, 2002.

### BACKGROUND

1. Field of the Invention

The present invention relates generally to interactive software engineering tools including editors for source code such as a programming code or mark-up language, and more particularly to facilities for supporting edit or other operations on a token-oriented representation of code or content.

2. Description of the Related Art

In an editor for computer programs, it can be desirable to represent program code using a token-oriented representation, rather than simply as a linear sequence of characters. In such a representation, the linear sequence of characters that corresponds to program code may be divided into substrings corresponding to the lexical tokens of the particular language. In some implementations, this representation of a stream of tokens can updated incrementally after each user action (for example, after each keystroke) using techniques such as those described in U.S. Pat. No. 5,737,608 to Van De Vanter, entitled “PER KEYSTROKE INCREMENTAL LEXING USING A CONVENTIONAL BATCH LEXER.” In general, such updates may employ a facility that allows insertion and/or deletion of tokens in or from the token stream.

Such updates may be expressed in terms of particular token-coordinates positions in a token stream, referring to a particular token and location of a particular character in the token. Although some operations of an editor may be expressed in this way, other operations, particularly text-oriented operations or program state accesses employed by some programming tools such as compilers, source-level debuggers etc., may benefit from traversal of a program representation as if it were organized as lines of code or other content. What is needed is a representation that satisfies both requirements and can efficiently support frequently performed operations, such as insertion of tokens in and/or deletion of tokens from the representation.

A commonly supported and highly desirable function of conventional text editors is “Undo-Redo.” This function permits a user to reverse the effects of the most recently performed editing operation (i.e., to Undo it), and then optionally to reverse the undo in order to get back to the original state (i.e., Redo the Undo). It is generally desirable for such Undo-Redo functionality to permit a compound or multi-step Undo operation, thereby permitting the user to unwind as many of the most recently performed editing operations as desired. A compound Redo correspondingly reverses a sequence of Undo operations.

### SUMMARY

While undo-redo facilities are common in conventional text editors that employ a conventional text buffer, provision of an undo-redo facility in a software engineering tool environment that employs a token-oriented representation of program code presents unique design challenges. In general, it would desirable if undo-redo operation support could be provided for an underlying token-oriented representation in a way that ensures that such operations take no more time than other basic editing operations. In particular, it is desirable for computational requirements associated with undo-redo operations to scale such that an operation takes no more than O(N) time, where N corresponds to the size of the operation (i.e., content inserted or deleted) and where the computational requirements are generally insensitive to the size of the program being edited.

For a software engineering tool that has an insertion point representation susceptible to change as a result of undo-redo operations, scaling behavior of computations associated with insertion point update can also be important. As before, scaling should generally be insensitive to the size of the program being edited. Such scaling behavior can be particularly important in software engineering tools that track character coordinates, buffer length or other similar attributes that may be affected by an edit operation.

Accordingly, it has been discovered that an editor, software engineering tool or collection of such tools may be configured to represent (or employ an encoding of) program code as an ordered set of lexical tokens and to maintain, coincident with an operation that modifies contents of the set, an undo object that identifies a pre-modification state of an insertion point. Typically, the pre-modification state includes both a token coordinates and a line coordinates representation of the insertion point and storage of pre-modification state in, or in association with, the undo object facilitates efficient implementation of a undo operation, e.g., generally without recomputation of a coordinate representation that would otherwise scale with buffer size. Efficient implementations of insert and remove operations that employ such a representation are described herein. Computational costs of such operations typically scale at worst with the size of fragments inserted into and/or removed from such a token-oriented representation, rather than with buffer size. Accordingly, such implementations are particularly well-suited to providing efficient support for programming tool environments in which a token stream is updated incrementally in correspondence with user edits. These and other implementations will be understood with reference to the specification and claims that follow.

In some implementations, the undo object also identifies a sublist of one or more lexical tokens corresponding to a substring that is either inserted into or removed from the list by an edit operation. In this way, lexical tokens corresponding to an inserted substring can be readily and efficiently excised to restore a pre-insertion tokenized list state. Similarly, lexical tokens corresponding to a removed substring can be readily and efficiently reinstated to restore a pre-deletion tokenized list state. Advantageously, undo support once employed to restore a prior tokenized list state is symmetrically available to support redo operations. In some embodiments in accordance with the present invention, undo-redo entries are maintained in an operation ordered set that is traversed to support one or more operations in either the undo or redo directions. In some realizations, such an ordered set of undo-redo entries is maintained by, or in conjunction with, an undo-redo manager.

By identifying a pre-modification state of an insertion point, even lengthy, complex undo (or redo) sequences can be supported with a computational overhead that scales with the number of undone (or redone) operations rather than buffer size or even size of the edits performed. As a result, a software engineering tool that employs techniques in accordance with the present invention provides extremely efficient undo-redo support even in software engineering environments that handle large bodies of program code or that provide language-oriented features such as advanced program typography or editor behavior specialized based on lexical context.

### BRIEF DESCRIPTION OF THE DRAWINGS

The present invention may be better understood, and its numerous objects, features, and advantages made apparent to those skilled in the art by referencing the accompanying drawings.

FIG. 1 depicts operation of one or more software engineering tools that operate on and/or maintain a tokenized program representation in accordance with some embodiments of the present invention.

FIG. 2 depicts in greater detail a tokenized program representation with an insertion point encoding in accordance with some embodiments of the present invention.

FIGS. 3A, 3B, 3C and 3D illustrate, in accordance with some embodiments of the present invention, states of a tokenized program representation and of related undo-redo representations in relation to operations that insert tokens into the program representation, typically in response to user edits. In particular, FIGS. 3A and 3B illustrate states before and after an edit operation that inserts tokens into the representation. FIGS. 3C and 3D illustrate states after respective undo and redo operations.

FIGS. 4A, 4B, 4C and 4D illustrate, in accordance with some embodiments of the present invention, states of a tokenized program representation and of related undo-redo representations in relation to operations that remove tokens from the program representation, typically in response to user edits. In particular, FIGS. 4A and 4B illustrate states before and after an edit operation that removes tokens from the representation. FIGS. 4C and 4D illustrate states after respective undo and redo operations.

FIGS. 5A, 5B, 5C and 5D illustrate, in accordance with some embodiments of the present invention, states of a tokenized program representation and of related undo-redo representations in relation to operations that insert one or more additional line boundaries, typically in response to user edits. In particular, FIGS. 5A and 5B illustrate states before and after an edit operation that inserts into the representation, a fragment containing at least two EOL tokens. FIGS. 5C and 5D illustrate states after respective undo and redo operations.

FIGS. 6A and 6B illustrate, in accordance with some embodiments of the present invention, states of a tokenized program representation in relation to operations that delete a line boundary, typically in response to user edits. In particular, FIGS. 6A and 6B illustrate states before and after an edit operation that removes an EOL token from the representation.

FIG. 7 illustrates, in accordance with some embodiments of the present invention, an ordered set of undo-redo records together with a portion of a tokenized program representation after both an insertion of tokens into the representation and partial deletion of thereof.

FIG. 8 depicts interactions between various functional components of an exemplary editor implementation that employs a token-oriented representation and for which insertion point support may be provided in accordance with techniques of the present invention.

The use of the same reference symbols in different drawings indicates similar or identical items.

### DESCRIPTION OF THE PREFERRED EMBODIMENT(S)

Exploitations of the techniques of the present invention are many. In particular, a variety of software engineering tools are envisioned, which employ aspects of the present invention to facilitate edit and/or navigation operations on a token-oriented representation of program code. One exemplary software engineering tool is a source code editor that provides specialized behavior or typography based on lexical context using a tokenized program representation. Such a source code editor provides a useful descriptive context in which to present various aspects of the present invention. Nonetheless, the invention is not limited thereto. Indeed, applications to editors, analyzers, builders, compilers, debuggers and other such software engineering tools are envisioned. In this regard, some exploitations of the present invention may provide language-oriented behaviors within suites of tools or within tools that provide functions in addition to manipulation of program code.

In addition, while traditional procedural or object-oriented programming languages provide a useful descriptive context, exploitations of the present invention are not limited thereto. Indeed, other software engineering tool environments such as those adapted for editing, analysis, manipulation, transformation, compilation, debugging or other operations on functionally descriptive information or code, such as other forms of source code, machine code, bytecode sequences, scripts, macro language directives or information encoded using markup languages such as HTML or XML, may also employ structures, methods and techniques in accordance with the present invention. Furthermore, the structures, methods and techniques of the present invention may be exploited in the manipulation or editing of non-functional, descriptive information, such as software documentation or even prose. Based on the description herein, persons of ordinary skill in the art will appreciate applications to a wide variety of tools and language contexts.

Accordingly, in view of the above and without limitation, an exemplary exploitation of the present invention is now described.

Tokenized Program Representation

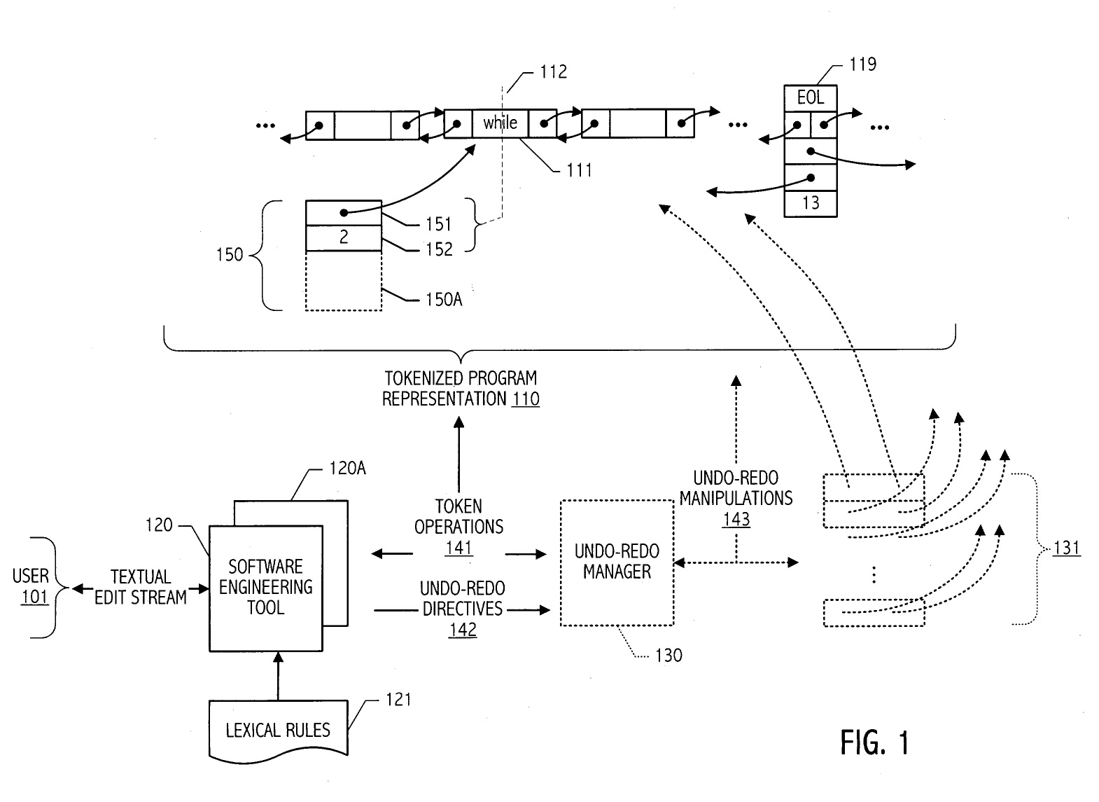

FIG. 1 depicts operation of one or more software engineering tools (e.g., software engineering tools 120 and 120A) that operate on, maintain and/or traverse a tokenized representation of information, such as tokenized program representation 110. In FIG. 1, a doubly-linked list representation of tokenized program code is illustrated with line boundary demarcations. Of course, any of a variety of variable-size structures that support efficient insertion and removal may be employed. For example, although the illustration of FIG. 1 suggests plural nodes configured in a doubly-linked list arrangement with textual information associated with each such node, other information and coding arrangements are possible. In some realizations, node-associated information may be encoded by reference, i.e., by a pointer identifying the associated information, or using a token code or label. In some variations, identical textual or other information content associated with different nodes may be encoded as multiple pointers to a same representation of such information. In some realizations, information may even be encoded in the body of a node's structure itself. Whatever the particular design choice, the illustrated doubly-linked list encoding provides a flexible way of representing the tokenized program content and provides a useful illustrative context.

In general, language-oriented properties can be separated from the list structure. For example, in the illustrated tokenized program representation 110, a character sequence (e.g., that corresponding to a computer program or portion thereof) is represented as a doubly-linked list of text strings, while the language (lexical) properties of the strings can be isolated from the list structure by storing references to associated strings in each node. In this way, structures and methods of manipulation can be implemented without bias to a particular language, and language-oriented behaviors can be implemented or supported in a modular fashion. In addition, multiple lexical contexts and/or embedded lexical contexts may be efficiently supported. In general, when a character sequence is stored or represented, the total amount of storage or memory employed can be substantially reduced by storing a pointers to an associated text string encoding and such encodings may be referenced by the various nodes that correspond to uses of a particular string (or token) in a given program representation. Storage for the text strings can be managed separately from the storage for the nodes. For example, when allocating a string for a new node (or token), existing strings may be checked to see if a corresponding string already exists. Strings corresponding to valid language tokens may be pre-allocated and indexed using a token identifier, hash or any other suitable technique.

In the illustration of FIG. 1, an insertion point representation (e.g., insertion point 150) is used to identify a particular point in the tokenized list structure at which edit operations operate. The insertion point may be manipulated by navigation operations, as a result of at least some edit operations, or (in some configurations) based on operations of a programming tool such as a source level debugger. A variety of insertion point representations are suitable, including insertion point representations that encode line identifiers, line offsets, text offsets and/or total buffer size. The illustrated insertion point representation includes an encoding of token coordinates using token pointer 151 and offset 152 thereinto, together with a line coordinates encoding 150A. Typically, line coordinates encoding 150A identifies a relevant line boundary demarcation, e.g., end-of-line (EOL) token 119, together with additional information such as a line number and/or an offset into the line. Using such an insertion point representation, a particular position in tokenized program representation 110, e.g., position 112 immediately before the character “i” in the text string representation corresponding to language token 111, is identified. In addition, line-coordinates information is also encoded. The insertion point representation is maintained consistent with edit operations and navigation operations. In a given insertion point representation, additional information may also be encoded (and maintained) to facilitate operations of various software engineering tools. In particular, some representations include a further character-coordinates representation, e.g., total text offset into tokenized program representation 110, and a total buffer length encoding.

Many variations on the illustrated insertion point representation are envisioned. For example, in some exploitations, additional character-coordinates representations may be may be included while in others such features may be omitted, disabled or unused. Similarly, total buffer length and/or line length encodings are optional for some exploitations. In addition, while straightforward implementations tend to represent offsets as positive offsets from a lowest order base position (e.g., a positive text offset from a beginning of string or beginning of token position), other variations are possible. For example, offsets (including negative offsets) from other positions such as an end of string or token position (or line or buffer boundary) may be employed. More generally, any arbitrary base/offset convention may be employed, including from arbitrary or predetermined way points in a program representation. These and other variations may fall within the scope of certain claims that follow. Nonetheless, for clarity of illustration, the description that follows focuses on a straightforward zero-base and positive offset convention.

Furthermore, insertion point representations are susceptible to a variety of suitable encodings including as data structures that identically or non-identically represent some or all of the data of the illustrated insertion point representation 150. For example, data may be encoded in, or in association with, an insertion point representation to improve the efficiency of manipulations of the tokenized program representation. Similarly, certain aspects of the represented data may be hierarchically organized and/or referenced by value to facilitate transformations and/or undo-redo caching that may be employed in some realizations. For purposes of this description, any of a variety of insertion point encodings are suitable.

As illustrated in FIG. 1, one or more software engineering tools may operate on the contents of tokenized program representation 110 using token operations 141. Illustrative token operations include insertion and removal of tokens in or from tokenized program representation 110. Lexical rules 121 facilitate decomposition, analysis and/or parsing of a textual edit stream, e.g., that supplied through interactions with user 101, to transform textual operations into token oriented operations. In general, any of a variety of lexical analysis techniques may be employed. However, in some implementations, tokens are updated incrementally after each user action (for example, after each keystroke) using incremental techniques such as those described in U.S. Pat. No., 5,737,608 to Van De Vanter, entitled “PER KEYSTROKE INCREMENTAL LEXING USING A CONVENTIONAL BATCH LEXER,” the entirety of which in incorporated herein by reference. Other lexical analysis techniques may be employed in a given implementation. Whatever the techniques employed, a textual edit stream will, in general, result in updates to tokenized program representation 110 that can be defined in terms of insertions and deletions of one or more tokens thereof. The description that follows describes insertion and deletion operations and associated representations that facilitate efficient handling of such operations.

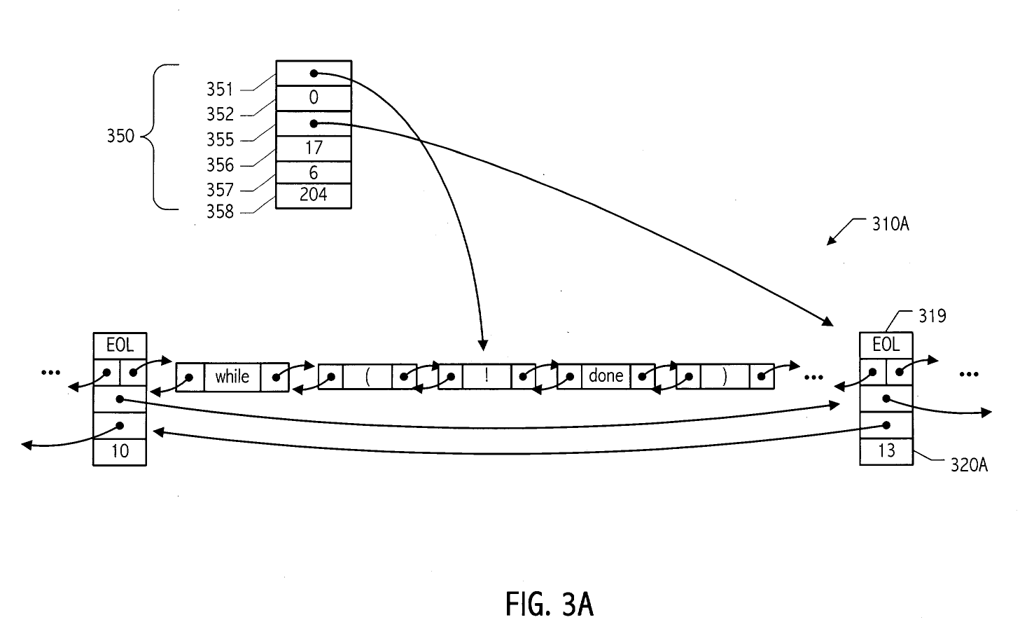

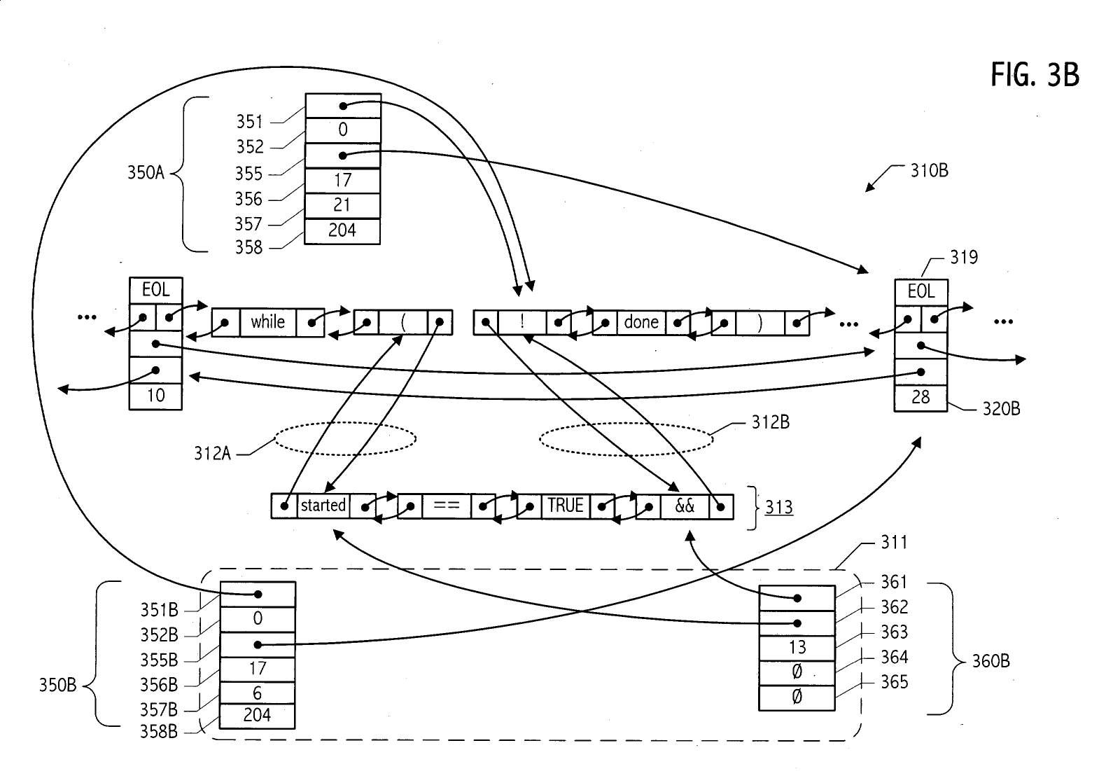

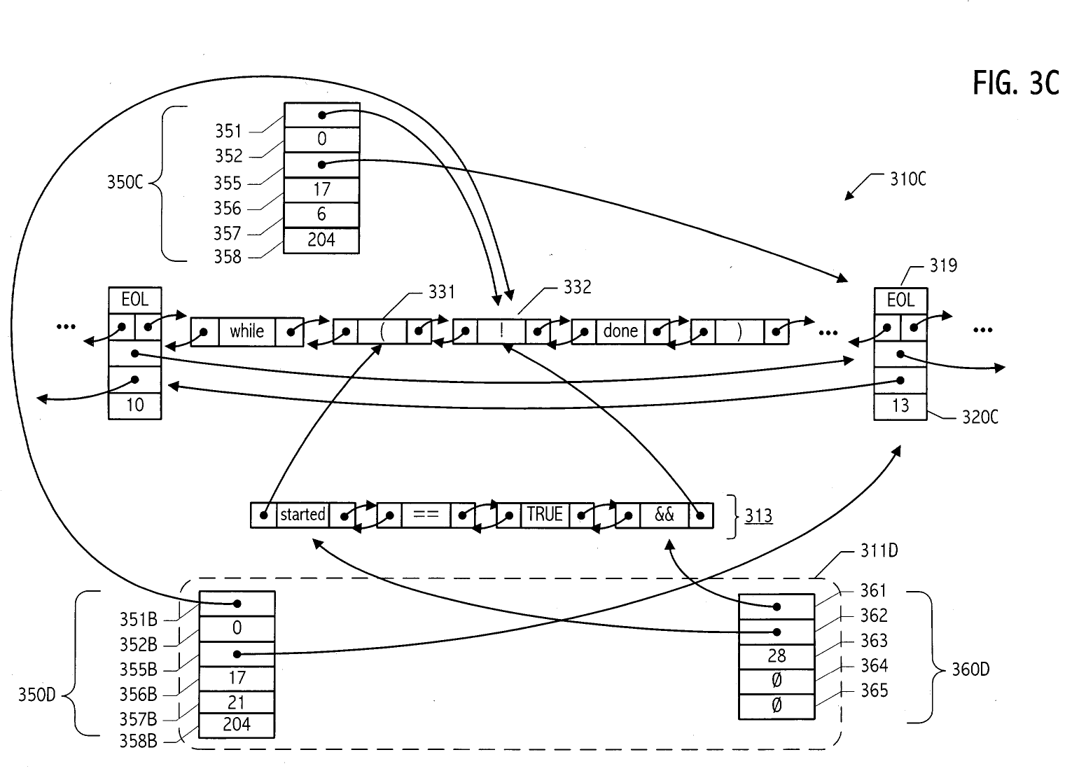

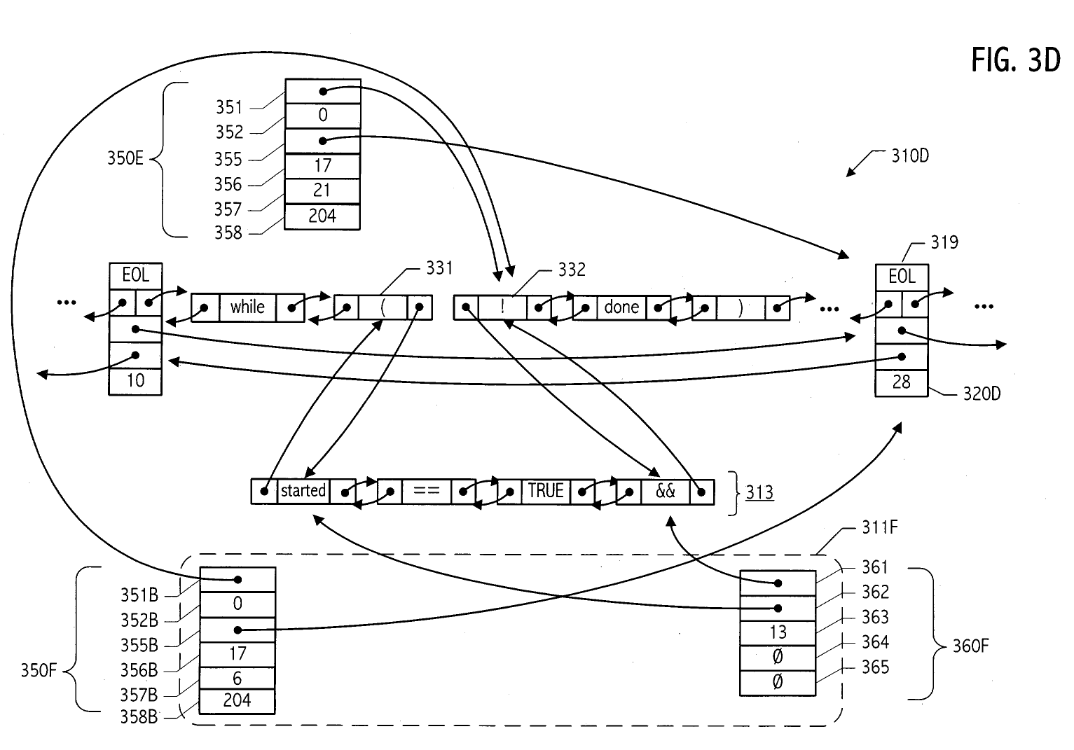

An undo-redo manager 130 maintains a collection 131 of undo-redo objects or structures that facilitate manipulations of tokenized program representation 110 to achieve the semantics of undo and redo operations. In general, such an undo-redo manager is responsive to undo-redo directives 142 supplied by software engineering tool 120 and interacts with tokenized program representation 110 and the undo-redo objects in accordance therewith. Typically, undo-redo directives are themselves responsive to user manipulations, although other sources (such as from automated tools) are also possible. In the illustration of FIG. 1, individual undo-redo structures identify respective nodes of the tokenized program representation (including those corresponding to inserted or removed tokens) to facilitate undo and redo operations as now described with reference to FIGS. 3A through 7. Undo-redo manager implementations for editors that represent content in a text buffer are well known in the art, see e.g., Finseth, The Craft of Text Editing, Springer-Verlag (1991). Indeed, one suitable undo-redo manager framework that may be extended with objects and methods described herein is the Swing graphical user interface (GUI) component toolkit, part of the Java Foundation Classes (JFC) integrated into Java 2 platform, Standard Edition (J2SE), available from Sun Microsystems, Inc. In particular, the subclass javax. swing. undo. UndoManager (available at java.sun.com) and its related classes, objects and methods provide one exemplary implementation of a suitable undo-redo manager implementation framework.

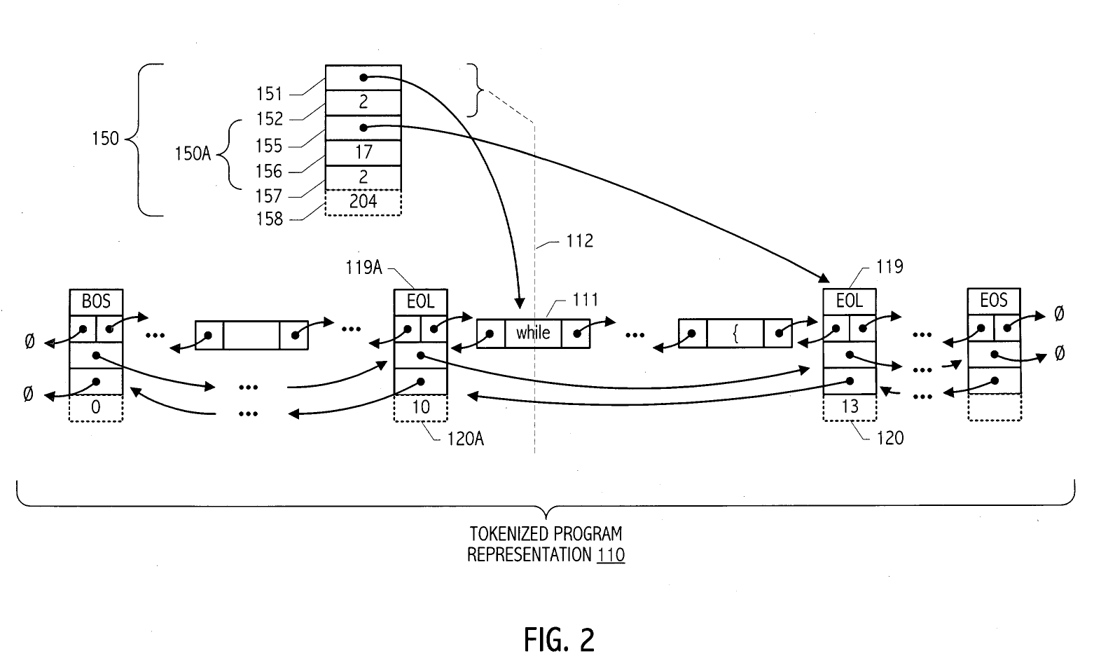

Undo-Redo techniques will be understood in the context of an illustrative program representation now described with reference to FIG. 2. In particular, FIG. 2 depicts an illustrative state for a tokenized program representation including EOL tokens and an insertion point encoding. As before, tokenized program representation 110 includes a doubly-linked list of lexical tokens and an insertion point representation 150 that identifies a particular position 112 therein. End-of-line EOL tokens (e.g., 119, 119A) mark line boundaries in the illustrated representation. Beginning-of-stream (BOS) and end-of-stream (EOS) are encoded as null terminated EOL tokens, although other realizations may employ other encodings. While appropriate line termination conventions may vary from system-to-system or implementation-to-implementation, in many systems and implementations, EOL tokens correspond to newline characters and, for the sake of illustration (though without limitation), the description that follows so-presumes.

In addition to the bi-directional intertoken pointers illustrated, tokenized program representation 110 provides an additional line-to-line traversal facility using an overlaid doubly-linked chain of pointers from EOL token to EOL token. An appropriate one of these EOL tokens (e.g., EOL token 119 which terminates the line in which position 112 resides) is identified by pointer 155 of line coordinates encoding 150A. Of course, use of a terminating EOL token (rather than, for example, a preceding token or other demarcation), is by convention only and other realizations may employ other conventions. In the illustrated configuration, line coordinates encoding 150A caches a line number (156) for the line which includes position 112 and a line offset (157) into the line in which position 112 appears.

The illustrated state of tokenized program representation 110 is state consistent with program code in which the textual content:

while (!done) {

appears at line 17 of a stream of edit buffer. Insertion point representation 150 includes both a token coordinates representation of the insertion point (e.g., where position 112 is identified as offset of 2 [see field 152] into token 111 identified by pointer 151) and a line-coordinates representation of the insertion point (e.g., position 112 is identified as using a line offset of 2 [see field 157] into the particular line 17 [see field 156] terminated by EOL token 119 identified by pointer 155). Not all fields need be provided in a given realization. Several additional optional features are also illustrated. For example, insertion point representation 150 caches (at field 158) a total line count (e.g., 204 lines).

FIGS. 3A, 3B, 3C and 3D illustrate successive states of a tokenized program representation that is manipulated in response to an insert operation (i.e., an operation that inserts one or more tokens) and successive undo and redo operations. In FIG. 3A, we illustrate a partial state 310A of the tokenized program representation in which program code has been tokenized in accordance with lexical rules appropriate for a programming language, such as the C programming language. For simplicity of illustration, only a partial state corresponding to a fragment,

. . . while (!done) . . . ,

of the total program code is illustrated and the illustrated insertion adds a token chain corresponding to an additional predicate.

Insertion point representation 350 depicts an insertion point state corresponding to a position immediately preceding the “!” character as it exists prior to operation of the illustrated insertion. In particular, insertion point representation 350 includes a token-coordinates representation, i.e., pointer 351 identifies the corresponding node of the tokenized program representation and offset 352 identifies the offset (in this case, offset=0) thereinto. Line-coordinates are further represented in insertion point representation 350 using pointer 355 (which identifies EOL token 319) and an offset thereinto (see field 357, encoding an offset of 6 character positions into the line identified by pointer 355). As before, polarity (e.g., direction) and base for line offset calculations is, by convention from positive from beginning of line although other conventions may be employed in other realizations. Insertion point representation 350 caches a line number (e.g., line 17, see field 356) corresponding to the insertion point. EOL token 319 optionally encodes a line length (e.g., 13 character positions, see field 320A. and insertion point representation 350 optionally caches a total line count (e.g., 204 total lines, see field 358).

Turning to FIG. 3B, we illustrate the result of an insertion into the tokenized program representation (pre-insertion state 310A) of four additional tokens (fragment 313) corresponding to user edits of the program code. In the illustration of FIG. 3B, updates to bi-directional pointers 312A and 312B effectuate the token insertion into the tokenized program representation resulting in post-insertion state 310B. A post insertion state 350B of the insertion point is maintained in correspondence with the insertion. Based on the illustrated insertion point convention and the particular insertion illustrated, no update to token identifier or offset thereinto is necessary. However, additional fields are updated in accordance with the particulars of inserted fragment 313. In particular, line offset (field 357) is updated to reflect the insertion of 15 character positions. Field 320B of EOL token 319 is similarly updated. In the illustrated configuration, any between-token whitespace is excluded in the calculation of updated character coordinates and total buffer length although other conventions may be employed in other implementations. Simple arithmetic updates based in the length of strings corresponding to inserted fragment 313 are suitable.

An undo-redo structure 311 is illustrated, which directly identifies (through respective pointers 361 and 362) opposing ends of the inserted fragment 313. In addition, undo-redo structure 311 includes a stored (or cached) insertion point representation 350B corresponding to the insertion point state and total line count state that existed prior to operation of the illustrated insertion. Token pointer 351B, in-token character offset field 352B, next EOL token pointer 355B, line number field 356B and in-line character offset field 357B, and total line count field 358B encode respective pre-insertion states. For efficiency of manipulation (and convenience of illustration), the structure of an insertion point representation 350B generally corresponds to that of the current insertion point state 350A and other pointers and pointers and fields, including a pre-insertion state 363 of line length field (e.g., 320B) of EOL token 319, are illustrated in grouping 360B. Remaining lastEOL and firstEOL pointer fields 364 and 365 are null in the illustrated example.

Of course, implementations may employ differing representations, if desired. For example, rather than explicitly encoding data corresponding to certain fields, an appropriate integer modifier may be encoded and the full state of the illustrated insertion point representation arithmetically regenerated using the integer modifier and other baseline information in the undo-redo structure. For simplicity, only the undo-redo structure associated with the illustrated insertion is shown in FIG. 3B. However, based on the description herein, persons of ordinary skill in the art will appreciate that a total representation of program code and undo-redo state may (and typically does) include additional undo-redo structures.

Of note, a sequence of N tokens (including corresponding strings) can be inserted into, or deleted from, an arbitrary sequence of characters of arbitrary length stored as illustrated above and appropriate undo-redo information maintained, all in O(N) time. The O(N) computational overhead associated with insertion or deletion includes updates to the next EOL pointer and to line number and line offset cached in the insertion point representation. If EOL tokens are inserted or deleted (e.g., in the case of a multiline insertion or deletion) links amongst the EOL are also updatable in O(N) time. In short, when a linear sequence of characters is stored as a doubly-linked list of tokens (with corresponding strings), insertion of new characters is implemented as an insertion of one or more list nodes. Similarly, deletion is implemented as excision of one or more list nodes. In either case, computational costs are advantageously independent of total buffer length.

Turning to FIG. 3C, we illustrate results of an undo operation that reverses the effect on the tokenized program representation of the previously executed insertion operation. Note that, while the doubly-linked list state is restored, the previously inserted fragment 313 of tokens continues to be represented and identified by a corresponding undo-redo structure, namely undo-redo structure 311D. Furthermore, the previously inserted program fragment (now excised from the tokenized program representation, state 310C) maintains its identification of splice point nodes of in the tokenized program representation, namely splice point nodes 331 and 332. In this way, the states of the tokenized program representation and of the previously inserted, but undone, fragment 313 identified by undo-redo structure 311D are well situated to support redo of the previously undone insertion. To effectuate insertion point restoration, the stored (pre-insertion) insertion point representation 350B is swapped for that represented as current insertion point state 350A (recall FIG. 3B). The resulting swapped states are illustrated in FIG. 3C. For efficiency of undo operation execution, such a swap may be implemented using a swap of pointers (not specifically shown) to respective data structures. Of course, other implementations (including use of object clones or simply swapping objects) may be suitable in a given realization.

To effectuate efficient restoration of other aspects of the tokenized program representation state, pointers and fields grouped as 360B are employed. In particular, the stored (pre-insertion) state 363 of line length field (recall state 320A in FIG. 3A) is swapped for then current line length state 320B of EOL token 319. The result is illustrated in FIG. 3C. First token and last token pointers 362 and 361 identify opposing ends of previously inserted fragment 313 to facilitate efficient excision (and later re-splice) of the fragment into the tokenized program representation state. As before, firstEOL and lastEOL pointer fields 365 and 364 are null in the illustrated example. After completion of the undo operation, undo-redo structure 311D provides state information to support efficient redo.

Results of a subsequent redo are illustrated in FIG. 3D. Reinstatement of the token insertion into the tokenized program representation is effectuated by re-establishing the bi-directional pointer chain through previously inserted (and previously-undone) fragment 313, resulting in post-redo state 310D. Of note, undo-redo structure 311D state (see FIG. 3C) provides the reference chains that allow update of respective pointers of splice point nodes 331 and 332 to efficiently redo the previously undone insertion of fragment 313. After completion of the redo operation, undo-redo structure 311F continues to identify (through respective pointers 361 and 362) opposing ends of the now re-inserted fragment 313. In this way, a subsequent undo may be efficiently supported.

As before, to effectuate insertion point restoration, the stored (post-insertion) insertion point representation 350D is swapped for that represented as current insertion point state 350C (recall FIG. 3C). The resulting swapped states are illustrated in FIG. 3D. To effectuate efficient restoration of other aspects of the tokenized program representation state, stored pointers and fields grouped as 360D are employed. In particular, the stored (post-insertion) state 363 of line length field (recall state 320B in FIG. 3B) is swapped for then current line length state 320C of EOL token 319. The result is illustrated in FIG. 3D. First token and last token pointers 361 and 362 identify opposing ends of previously inserted fragment 313 to facilitate efficient excision of the fragment from the tokenized program representation state 310D. It is noteworthy that the states illustrated in FIGS. 3B and 3D are equivalent. As a result, it is clear that alternating undo and redo operation sequences of indefinite length may be performed while preserving desired behavior and state.

Based on the description above, persons of ordinary skill in the art will appreciate a variety of suitable functional implementations to support the above-described insertions and deletions. The exemplary code that follows illustrates one such suitable functional implementation and will be understood in the context of the following data structure or class definitions.

```
// Represents a token in a doubly linked list.
// There are sentinel tokens at each end of the list, so that
// no pointers in tokens which are proper members of the list
// are null.
    class Token {
    public Token next;
    public Token previous;
    public String text;
    ....
}
// Represents a special End of Line token in a doubly linked list of
// text tokens. All the End of Line tokens in a stream are themselves
// doubly linked, including the Beginning of Stream and End of Stream
// sentinels (which are special cases of End of Line tokens). The
// End of Line token contains a cache of the number of characters
// between this token and the previous End of Line token (excluding
// the newline characters they contain).
class EOLToken extends Token {
  public EOLToken nextEOL = null;
  public EOLToken previousEOL = null;
  public int lineLength = 0;
  ...
}
// Represents a stream of tokens, represented as a doubly linked list
// with beginning and ending sentinels. Special End of Line tokens
// separate lines, and are doubly linked together, including the
// special Beginning of Stream and End of Stream sentinels (which are
// special instances of End of Line tokens).
// The total number of lines in the stream is cached at all times.
public class TokenStream {
  EOLToken bos = new EOLToken( );
  EOLToken eos = new EOLToken( );
  int lineCount = 0;
  ...
}
// Represents a character position where editing operations may be
// performed in a doubly linked list of token nodes. The position is
// represented, and maintained, in two formats:
// - a pointer to a token and a character offset into the token
// - a line number and a character offset into the line
// The point also maintains a pointer to the EOLToken that terminates
// the current line; this may be the same token, when point is
// positioned at EOL, and it may be the EOS sentinel when point is
// positioned at EOF.
class Point {
  public TokenStream stream;
  public Token token;
  public int tokenOffset;
  public int lineNumber;
  public int lineOffset;
  public EOLToken eol;
  ...
}
```

Turning now to support for token-coordinates and line-coordinates, the following exemplary code illustrates one suitable functional implementation of an insert operation.

```
// Represents a stream of tokens, represented as a doubly linked list
// with beginning and ending sentinels. Special End of Line tokens
// separate lines, and are doubly linked together, including the
// special Beginning of Stream and End of Stream sentinels (which are
// special instances of End of Line tokens).
// The total number of lines in the stream is cached at all times.
public class TokenStream {
  ...
  // Method for inserting tokens into a doubly linked list at a
  // point between tokens.
  // Precondition:
  // - <point> refers to the beginning of a token in a doubly
  // linked list of Tokens with sentinels, or possibly to the
  // ending sentinel. <point>.tokenOffset thus must be 0.
  // - <first> refers to the first of a doubly linked list of at
  // least one Token, which are not in the list referred to by
  // <point>;
  // - <last> refers to the last of these tokens
  // Postcondition:
  // - <point> points to the same position.
  // - The tokens beginning with <first> and ending with <last> are
  // in the token list, which is otherwise unchanged, immediately
  // prior to the token pointed to by <point>.
  // - The cached values in <point> for line number and line
  // offset,as well as the stream's line count and line sizes are
  // updated.
  public UndoRedo insert(TokenList tokenList, Point point) {
    UndoRedo undoRedo = new InsertUndoRedo(tokenList, point);
    Token lastBefore = point.token.previous;
    Token firstAfter = point.token;
    lastBefore.next = tokenList.first;
    tokenList.first.previous = lastBefore;
    tokenList.last.next = firstAfter;
    firstAfter.previous = tokenList.last;
    int oldLeadingChars = point.lineOffset;
    int oldFollowingChars = point.eol.lineLength −
                        point.lineOffset;
    int newChars = 0;
    int newLines = 0;
    for (Token t = tokenList.first; t != firstAfter; t = t.next) {
      if (t.isEOL( )) {
        EOLToken tEOL = (EOLToken)t;
        point.eol.previousEOL.nextEOL = tEOL;
        tEOL.previousEOL = point.eol.previousEOL;
        tEOL.nextEOL = point.eol;
        point.eol.previousEOL = tEOL;
        tEOL.lineLength = oldLeadingChars + newChars;
        newLines++;
        oldLeadingChars = 0;
        newChars = 0;
      } else {
        newChars += t.text.length( );
      }
    }
    lineCount += newLines;
    point.lineOffset = oldLeadingChars + newChars;
    point.lineNumber += newLines;
    point.eol.lineLength = oldLeadingChars + newChars +
                      oldFollowingChars;
    return undoRedo;
  }
  ...
}
```

Undo and redo support may be implemented according to the following exemplary code.

```
class InsertUndoRedo implements UndoRedo {
  private TokenList tokenList;
  private Token token;
  private int lineOffset;
  private int lineNumber;
  private int lineLength;
  private int lineCount;
  private EOLToken eol;
  public InsertUndoRedo (TokenList tokenList, Point point) {
    this.tokenList = tokenList;
    this.token = point.token;
    eol = point.eol;
    lineOffset = point.lineOffset;
    lineNumber = point.lineNumber;
    lineLength = eol.lineLength;
    lineCount = point.stream.lineCount;
  }
  // Exchange state with <point> and the values cached in
  // this object
  private void swapState(Point point) {
    int tempLineOffset = point.lineOffset;
    point.lineOffset = this.lineOffset;
    this.lineOffset = tempLineOffset;
    int tempLineNumber = point.lineNumber;
    point.lineNumber = this.lineNumber;
    this.lineNumber = tempLineNumber;
    int tempLineLength = eol.lineLength;
    eol.lineLength = this.lineLength;
    this.lineLength = tempLineLength;
    int tempLineCount = point.stream.lineCount;
    point.stream.lineCount = this.lineCount;
    this.lineCount = tempLineCount;
  }
  // Precondition:
  // - The state of the token list is just as it was when
  // the tokens were originally inserted and this object
  // created.
  // - <point> refers to the beginning of the token before
  // which the tokens were inserted.
  // Postcondition:
  // - <point> refers to the same position.
  // - The state of token list is just as it was before
  // the tokens were originally inserted; the inserted
  // tokens are not in the list.
  public void undo(Point point) {
    Token lastBefore = tokenList.first.previous;
    Token firstAfter = tokenList.last.next;
    lastBefore.next = firstAfter;
    firstAfter.previous = lastBefore;
    if (tokenList.firstEOL != null) {
      EOLToken lastEOLBefore =
        tokenList.firstEOL.previousEOL;
      EOLToken firstEOLAfter = tokenList.lastEOL.nextEOL;
      lastEOLBefore.nextEOL = firstEOLAfter;
      firstEOLAfter.previousEOL = lastEOLBefore;
    }
    swapState(point);
  }
  // Precondition:
  // - The state of the token list is just as before
  // the tokens were originally inserted and this object
  // created; the tokens beginning with <first> and ending
  // with <last> are not in the token list.
  // - <point> refers to the beginning of the token before
  // which the tokens were originally inserted.
  // Postcondition:
  // - <point> refers to the same position.
  // - The state of the token list is just as it was when
  // the tokens were originally inserted and this object
  // created; the inserted tokens are back in the list in
  // their inserted location.
  public void redo(Point point) {
    Token lastBefore = tokenList.first.previous;
    Token firstAfter = tokenList.last.next;
    lastBefore.next = tokenList.first;
    firstAfter.previous = tokenList.last;
    if (tokenList.firstEOL != null) {
      EOLToken lastEOLBefore =
        tokenList.firstEOL.previousEOL;
      EOLToken firstEOLAfter = tokenList.lastEOL.nextEOL;
      lastEOLBefore.nextEOL = tokenList.firstEOL;
      firstEOLAfter.previousEOL = tokenList.lastEOL;
    }
    swapState(point);
  }
}
```

The preceding code is object-oriented and is generally suitable for use in a implementation framework such as that presented by the Java Foundation Classes (JFC) integrated into Java 2 platform, Standard Edition (J2SE). However, other implementations, including procedural implementations and implementations adapted to particular design constraints of other environments, are also suitable.

Arithmetic manipulations to support offset updates including token and line offsets (as well as character offsets, if provided) together with updates to total line counts and line length (as well as total buffer length, if provided) are simple and suitable code modifications corresponding to any particular base/offset convention employed will be appreciated based on the description herein. In general, in implementations that maintain insertion point information (as described above), line-coordinates of a current insertion point (as well as character-coordinates, if provided) can be determined in O(1), i.e., constant time, through simple arithmetic adjustments consistent with the character length of fragments inserted or removed from the tokenized program representation.

In the preceding illuustrative code, insertion is passed a TokenList object for which first and last EOL tokens (if included) have already been identified. Identification of first EOL and last EOL facilitates undo-redo as later described and may be provided in TokenList assembly as follows:

```
// A doubly linked list of Tokens
public class TokenList {
  Token first = null;
  Token last = null;
  EOLToken firstEOL = null;
  EOLToken lastEOL = null;
  public TokenList( ) {
  }
  public void append(Token token) {
    if (first == null) {
      first = token;
    } else {
      last.next = token;
      token.previous = last;
    }
    last = token;
    if (token.isEOL( )) {
      lastEOL = (EOLToken)token;
      if (firstEOL == null) firstEOL = (EOLToken)token;
    }
  }
  public void prepend(Token token) {
    if (first == null) {
      last = token;
    } else {
      first.previous = token;
      token.next = first;
    }
    first = token;
    if (token.isEOL( )) {
      firstEOL = (EOLToken)token;
      if (lastEOL == null) lastEOL = (EOLToken)token;
    }
  }
}
```

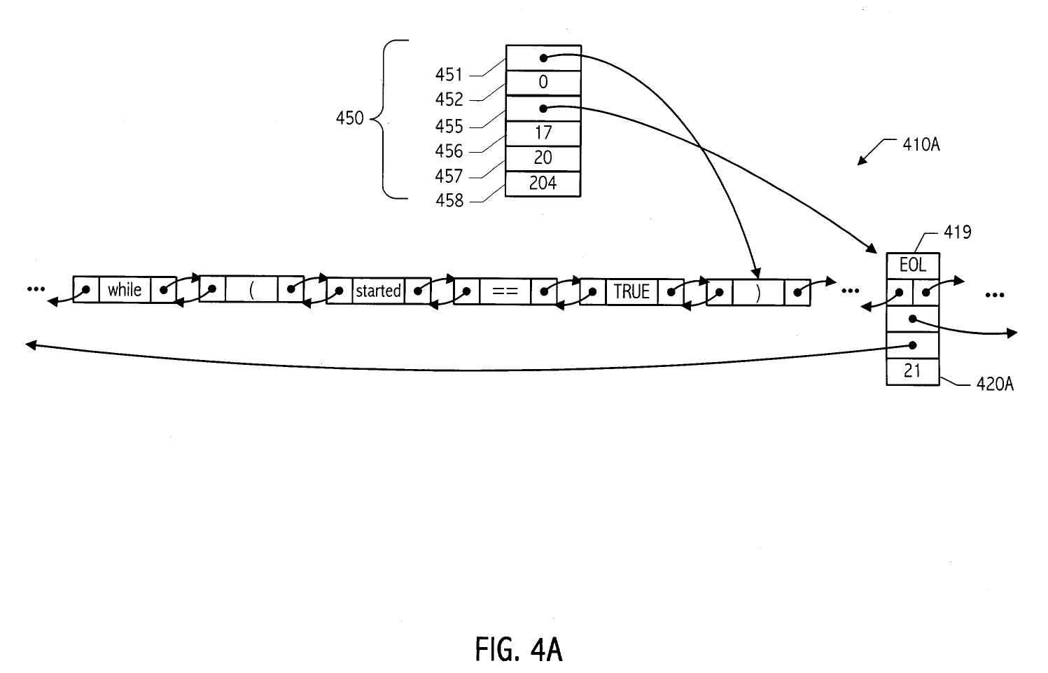

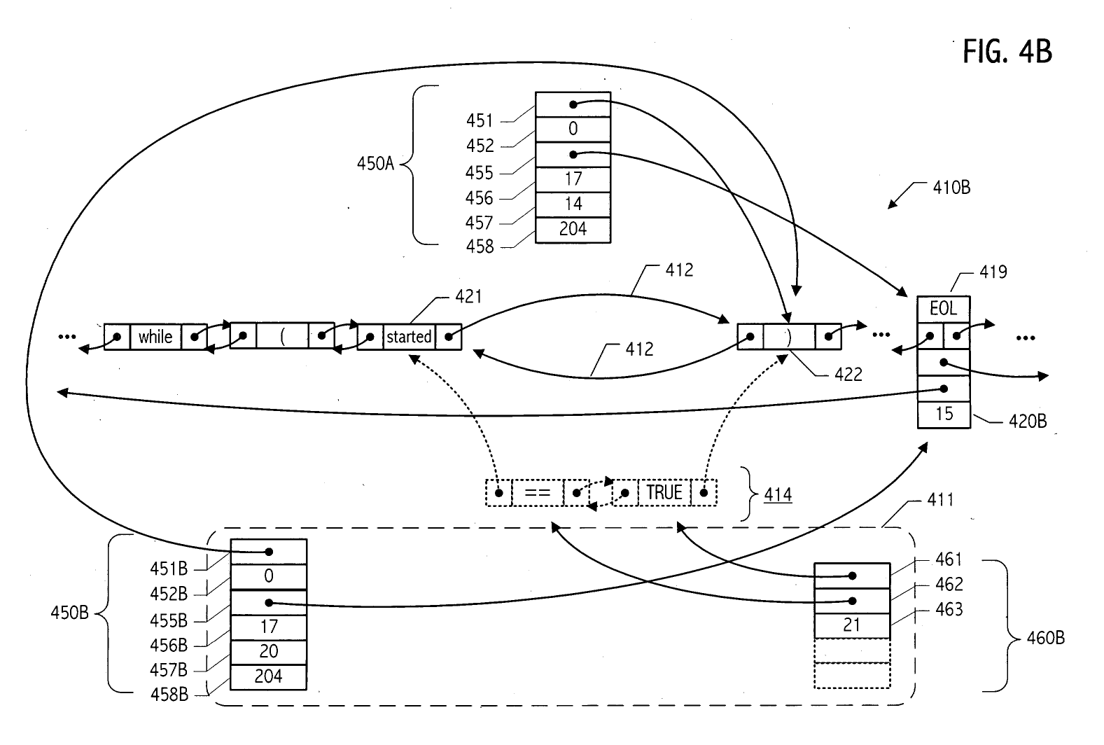

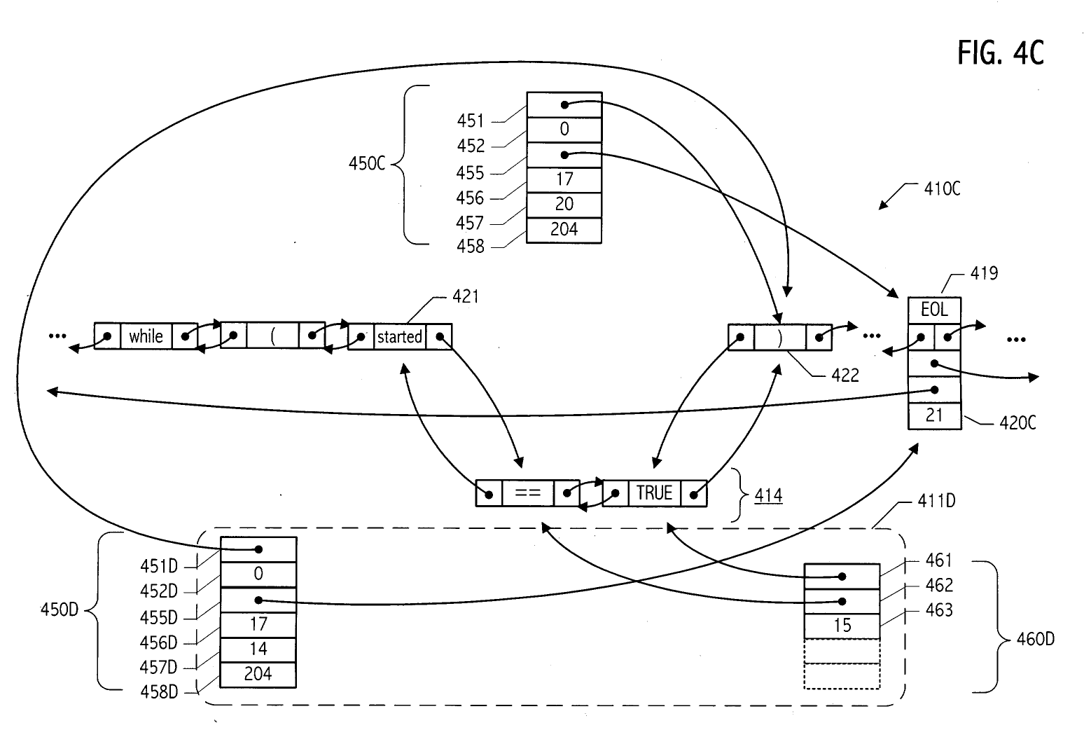

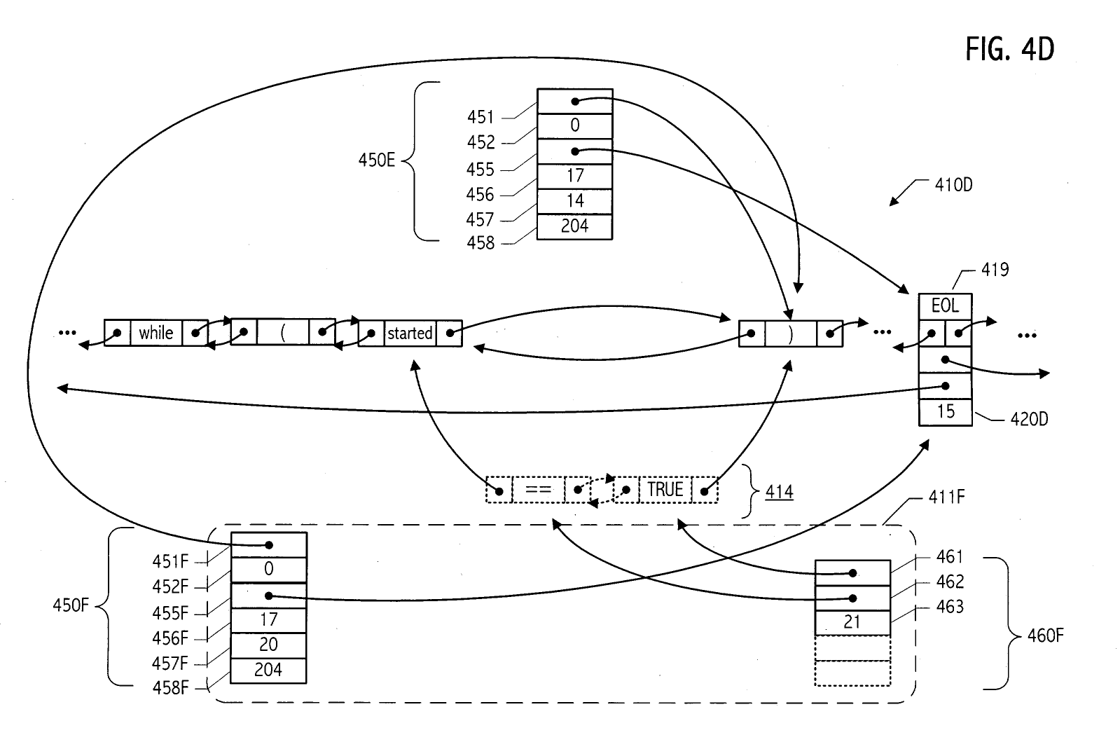

FIGS. 4A, 4B, 4C and 4D illustrate successive states of a tokenized program representation that is manipulated in response to a remove operation (i.e., an operation that removes one or more tokens) and successive undo and redo operations. As before, FIG. 4A illustrates an initial partial state 410A of a tokenized program representation. For simplicity, only a partial state corresponding to a fragment,

. . . while (started==TRUE) . . . ,

of the total program code is illustrated and the illustrated deletion removes tokens corresponding to potentially superfluous code.

Referring to FIG. 4A, insertion point representation 450 depicts an insertion point state corresponding to a position immediately preceding the “)” character as it exists prior to the operation of the illustrated removal. In particular, insertion point representation 450 includes a token-coordinates representation, i.e., pointer 451 identifies the corresponding node of the tokenized program representation and offset 452 identifies the offset (in this case, offset=0) thereinto. Line coordinates are represented in insertion point representation 450 using pointer 455 (which identifies EOL token 419) and an offset thereinto (see field 457, encoding an offset of 20 character positions into the line identified by pointer 455). Insertion point representation 450 caches a line number (e.g., line 17, see field 456) corresponding to the insertion point. EOL token 419 optionally encodes a line length (e.g., 21 character positions, see field 420A) and insertion point representation 450 optionally caches a total line count (e.g., 204 total lines, see field 458).

FIG. 4B then illustrates the result of a removal from the tokenized program representation (i.e., from pre-removal state 410A) of two tokens (fragment 414) corresponding to user edits of the program code. In the illustration of FIG. 4B, bi-directional pointers 412 are updated to bridge the excised fragment 414. A post removal state 450B of the insertion point is maintained in correspondence with the removal. Based on the illustrated insertion point convention and the particular removal illustrated, no update to token identifier or offset thereinto is necessary. However, additional fields that encode line offset (as well as a character-coordinates representation and total buffer length, if provided) are updated in accordance with the particulars of excised fragment 414. In particular, line offset (see field 457) is updated to reflect the deletion of 6 character positions. Field 420B of EOL token 419 is similarly updated. As before, between-token whitespace is excluded in the calculation of updated offsets, character coordinates and total buffer length although other conventions may be employed in other implementations. Simple arithmetic updates based in the length of strings corresponding to excised fragment 414 are suitable.

An undo-redo structure 411 is illustrated, which directly identifies (through respective pointers 461 and 462) opposing ends of the excised fragment 414. Note that excised fragment 414 maintains single direction pointers into respective excision point nodes 421 and 422 to facilitate efficient undo. Undo-redo structure 411 also includes a stored insertion point representation 450B corresponding to the insertion point state and total line count state that existed prior to operation of the illustrated deletion. Token pointer 451B, in-token character offset field 452B, next EOL token pointer 455B, line number field 456B and in-line character offset field 457B, and total line count field 458B encode respective pre-deletion states. For efficiency of manipulation (and convenience of illustration), the structure of an insertion point representation 450B generally corresponds to that of the current insertion point state 450A and other pointers and pointers and fields, including a pre-excision state 463 of line length field (e.g., 420B) of EOL token 419, are illustrated in grouping 460B. Remaining firstEOL and lastEOL pointer fields are unused in the illustrated removal operation and may be omitted from undo-redo structure 411 if desired. In general, it is desirable to keep the first EOL and the last EOL pointers. They are unused in the preceding example because the deleted region contains no EOL tokens. However, more generally, with first EOL and last EOL retained, Undo and Redo are both constant time operations. Alternatively, first and last EOL tokens could be located on-demand in order to maintain the line-related structure. However, scanning the region of the deletion again would make Undo and Redo computations scale as O (n) in the size of the change instead of O (1).

As before, for simplicity, only the undo-redo structure associated with the illustrated deletion is shown in FIG. 4B. However, based on the description herein, persons of ordinary skill in the art will appreciate that a total representation of program code and undo-redo state may (and typically does) include additional undo-redo structures.

Turning to FIG. 4C, we illustrate results of an undo operation that reverses the effect on the tokenized program representation of the previously executed removal operation. Note that, while the doubly-linked list state is restored, the previously excised fragment 414 of tokens continues to be identified by a corresponding undo-redo structure, namely undo-redo structure 411D. In this way, the states of the tokenized program representation and of the previously excised, but re-inserted, fragment 414 identified by undo-redo structure 411D are well situated to support redo of the previously undone removal. To effectuate insertion point restoration, the stored (pre-removal) insertion point representation 450B is swapped for that represented as current insertion point state 450A (recall FIG. 4B). The resulting swapped states are illustrated in FIG. 4C. To effectuate efficient restoration of other aspects of the tokenized program representation state, pointers and fields grouped as 460B are employed. In particular, the stored (pre-removal) state 463 of line length field (recall state 420A in FIG. 4A) is swapped for then current line length state 420B of EOL token 419. The result is illustrated in FIG. 4C. First token and last token pointers 462 and 461 identify opposing ends of previously excised fragment 414 to facilitate efficient re-excision (and later re-insertion) of the fragment from (into) the tokenized program representation state. After completion of the undo operation, undo-redo structure 411D provides state information to support efficient redo.

Results of a subsequent redo are illustrated in FIG. 4D. Reinstatement of the token fragment excision from the tokenized program representation is effectuated by reconfiguring the bi-directional pointer chain to bridge previously excised (and previously-undone) fragment 414, resulting in post-redo state 410D. Of note, undo-redo structure 411D state (see FIG. 4C) provides the reference chains that allow update of respective pointers of excision point nodes 421 and 422 to efficiently redo the previously undone removal of fragment 414. After completion of the redo operation, undo-redo structure 411F continues to identify (through respective pointers 461 and 462) opposing ends of the now re-excised fragment 414. In this way, a subsequent undo may be efficiently supported.

As before, to effectuate insertion point restoration, the stored (post-excision) insertion point representation 450D is swapped for that represented as current insertion point state 450C (recall FIG. 4C). The resulting swapped states are illustrated in FIG. 4D. To effectuate efficient restoration of other aspects of the tokenized program representation state, stored pointers and fields grouped as 460D are employed. In particular, the stored (post-excision) state 463 of line length field (recall state 420B in FIG. 4B) is swapped for then current line length state 420C of EOL token 419. The result is illustrated in FIG. 4D. First token and last token pointers 461 and 462 identify opposing ends of previously excised fragment 414 to facilitate efficient re-insertion of the fragment into the tokenized program representation state 410D. As before, it is noteworthy that the states illustrated in FIGS. 4B and 4D are equivalent. As a result, it is clear that alternating undo and redo operation sequences of indefinite length may be performed while preserving desired behavior and state.

The exemplary code that follows illustrates one suitable functional implementation of the above-described removal operation.

```
// Represents a stream of tokens, represented as a doubly linked list
// with beginning and ending sentinels. Special End of Line tokens
// separate lines, and are doubly linked together, including the
// special Beginning of Stream and End of Stream sentinels (which are
// special instances of End of Line tokens).
// The total number of lines in the stream is cached at all times.
public class TokenStream {
  ...
  // Method for deleting tokens from a doubly linked list
  // Precondition:
  // - <first> and <last> point to tokens in a doubly linked list
  // of Tokens with sentinels
  // - The token <first> is either the same as, or prior to the
  // token <last> in the list
  // - <point> refers to the beginning of the token just after
  // <last>
  // Postcondition:
  // - The tokens beginning with <first> and ending with <last> are
  // no longer in the token list, which is otherwise unchanged.
  // - The cached values in <point> for line number and line
  // offset, as well as the stream's line count and line sizes
  // are updated.
  public UndoRedo delete(Token first, Token last, Point point) {
    Token lastBefore = first.previous;
    Token firstAfter = last.next;
    EOLToken firstEOL = null;
    EOLToken lastEOL = null;
    int deletedCharacters = 0;
    int deletedFirstLineCharacters = 0;
    int deletedLines = 0;
    for (Token t = first; t != firstAfter; t = t.next) {
      if (t.isEOL( )) {
        deletedLines++;
        lastEOL = (EOLToken)t;
        if (firstEOL == null) {
          firstEOL = lastEOL;
          deletedFirstLineCharacters = deletedCharacters;
        }
      } else {
        deletedCharacters += t.text.length( );
      }
    }
    UndoRedo undoRedo = new DeleteUndoRedo(first, last, firstEOL,
                                          lastEOL, point);
    lastBefore.next = firstAfter;
    firstAfter.previous = lastBefore;
    if (firstEOL == null) {
      point.lineOffset −= deletedCharacters;
      point.eol.lineLength −= deletedCharacters;
    } else {
      EOLToken lastEOLBefore = firstEOL.previousEOL;
      lastEOLBefore.nextEOL = point.eol;
      point.eol.previousEOL = lastEOLBefore;
      int leadingCharacters = firstEOL.lineLength −
                          deletedFirstLineCharacters;
      int followingCharacters = point.eol.lineLength −
                            point.lineOffset;
      point.lineOffset = leadingCharacters;
      point.eol.lineLength = leadingCharacters +
                        followingCharacters;
      point.lineNumber −= deletedLines;
      lineCount −= deletedLines;
    }
    return undoRedo;
  }
  ...
```

Undo and redo support may be implemented according to the following exemplary code.

```
class DeleteUndoRedo implements UndoRedo {
  private Token first;
  private Token last;
  private EOLToken firstEOL;
  private EOLToken lastEOL;
  private Token token;
  private int lineOffset;
  private int lineNumber;
  private int lineLength;
  private int lineCount;
  private EOLToken eol;
  public DeleteUndoRedo(Token first, Token last, EOLToken firstEOL,
                      EOLToken lastEOL, Point point) {
    this.first = first;
    this.last = last;
    this.firstEOL = firstEOL;
    this.lastEOL = lastEOL;
    this.token = point.token;
    this.eol = point.eol;
    this.lineOffset = point.lineOffset;
    this.lineNumber = point.lineNumber;
    this.lineLength = eol.lineLength;
    this.lineCount = point.stream.lineCount;
  }
  // Exchange state with <point> and the values cached in this
  // object
  private void swapState(Point point) {
    int tempLineOffset = point.lineOffset;
    point.lineOffset = this.lineOffset;
    this.lineOffset = tempLineOffset;
    int tempLineNumber = point.lineNumber;
    point.lineNumber = this.lineNumber;
    this.lineNumber = tempLineNumber;
    int tempLineLength = eol.lineLength;
    eol.lineLength = this.lineLength;
    this.lineLength = tempLineLength;
    int tempLineCount = point.stream.lineCount;
    point.stream.lineCount = this.lineCount;
    this.lineCount = tempLineCount;
  }
  // Precondition:
  // - The state of the token list is just as it was when the
  // tokens were originally deleted and this object created.
  // - <point> refers to the beginning of the token in the stream
  // just after the deleted tokens.
  // Postcondition:
  // - <point> refers to the same position.
  // - The state of token list is just as it was before
  // the tokens were originally deleted; the deleted tokens
  // are back in the list in their original location.
  public void undo(Point point) {
    Token lastBefore = first.previous;
    Token firstAfter = last.next;
    lastBefore.next = first;
    firstAfter.previous = last;
    if (firstEOL != null) {
      firstEOL.previousEOL.nextEOL = firstEOL;
      eol.previousEOL = lastEOL;
    }
    swapState(point);
  }
  // Precondition:
  // - The state of the token list is just as it was after Undo was
  // invoked: the deleted tokens are in the list in their
  // original location.
  // - <point> refers to the beginning of the token in the stream
  // just after the deleted tokens.
  // Postcondition:
  // - <point> refers to the same position.
  // - The state of the token list is just as it was when the
  // tokens were originally deleted and this object created; the
  // tokens beginning with <first> and ending with <last> are no
  // longer in the token list, which is otherwise unchanged.
  public void redo(Point point) {
    Token lastBefore = first.previous;
    Token firstAfter = last.next;
    lastBefore.next = firstAfter;
    firstAfter.previous = lastBefore;
    if (firstEOL != null) {
      firstEOL.previousEOL.nextEOL = eol;
    eol.previousEOL = firstEOL.previousEOL;
    }
    swapState(point);
  }
}
```

While the previously described insertion and removal operations have been illustrated primarily in the context of a single operation, based on the description herein, persons of ordinary skill in the art will recognize that in a typical editing session, or for that matter, in the course of operation another programming tool, multiple insertions and removals of program fragments will occur. Indeed, large number of such insertions and removals will occur and, in general, can be represented as an ordered set of such operations. Often, one operation (e.g., a removal) will operate on results of the previous operation (e.g., an insertion). Accordingly, in the general case, it is desirable to represent an ordered set of undo-redo objects to facilitate the undoing and/or redoing of arbitrary sequences of operations.

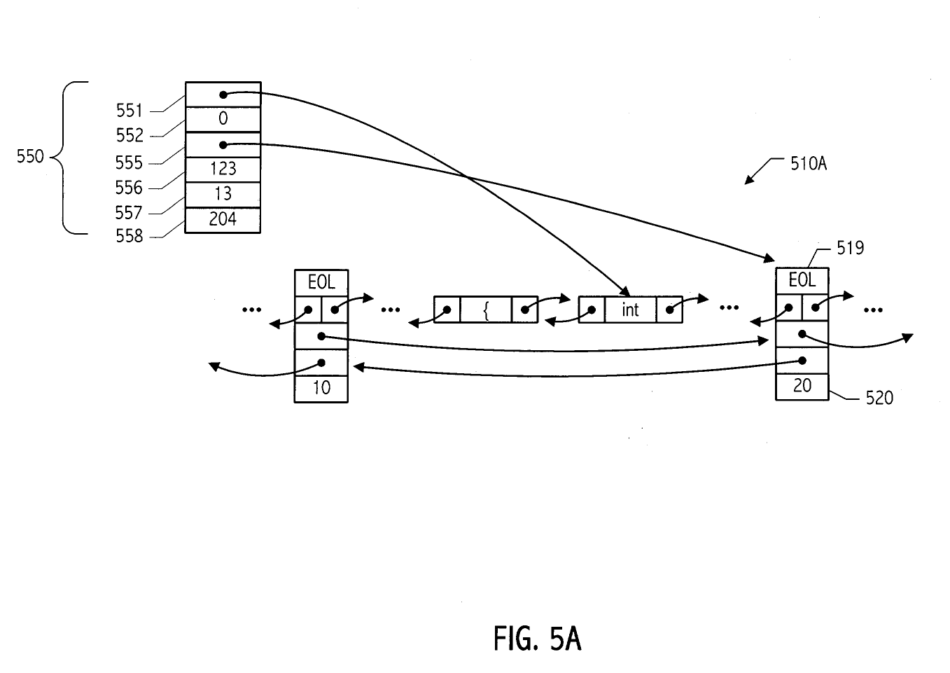

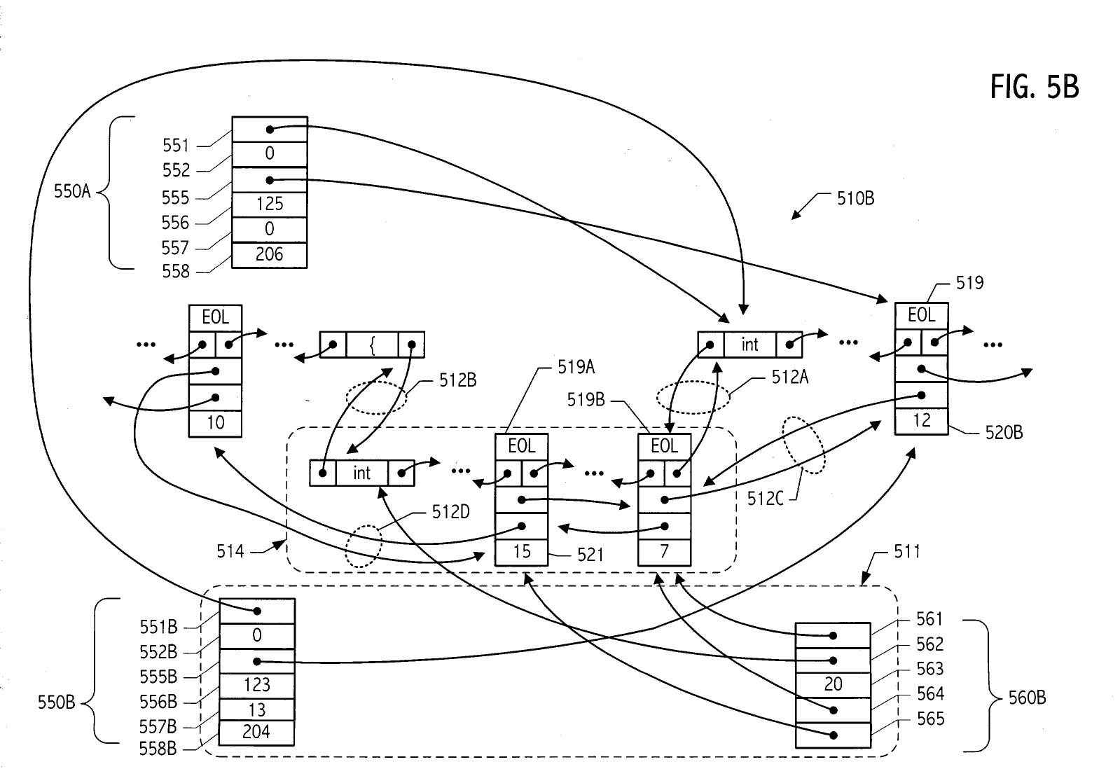

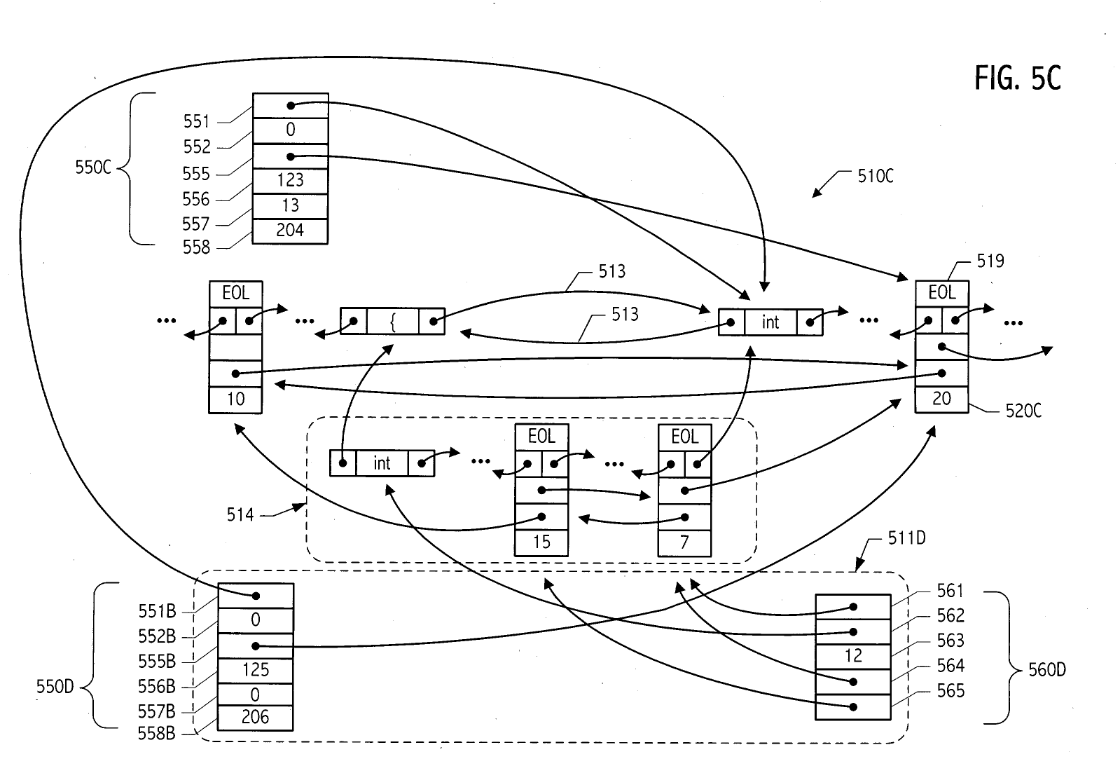

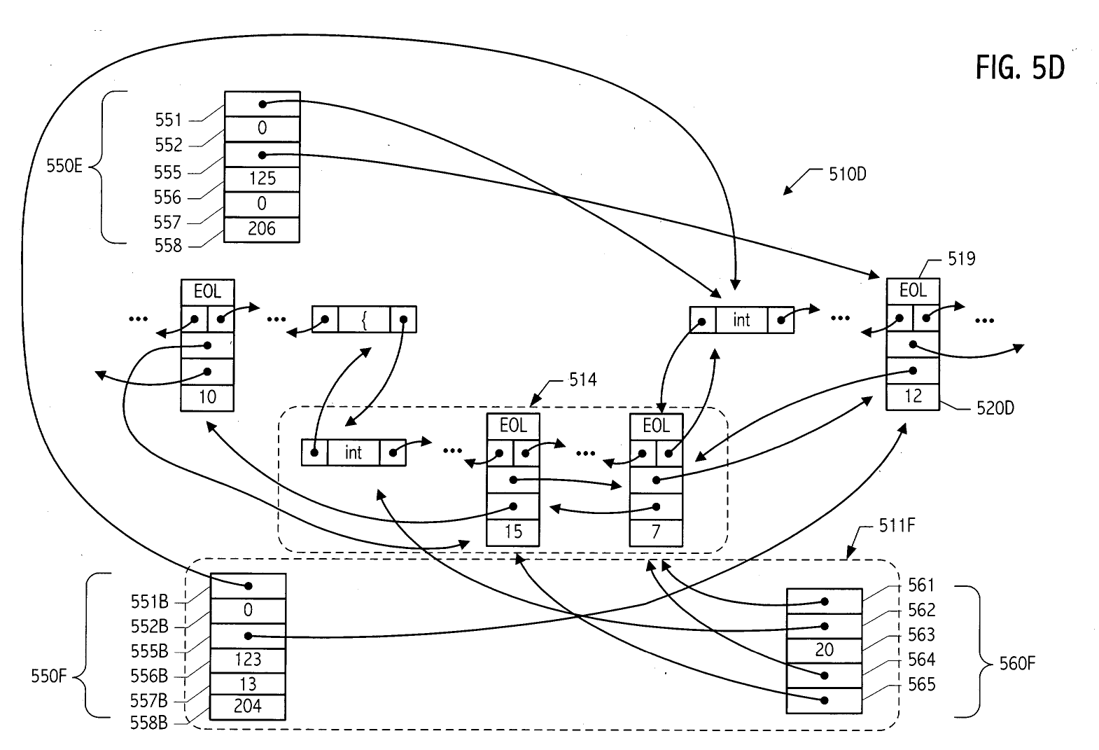

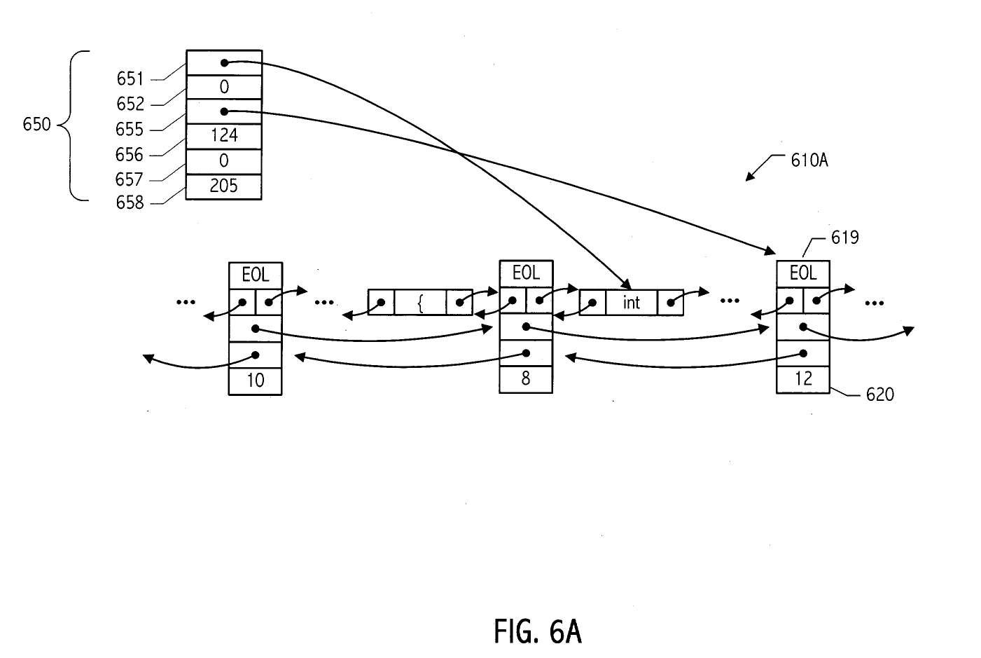

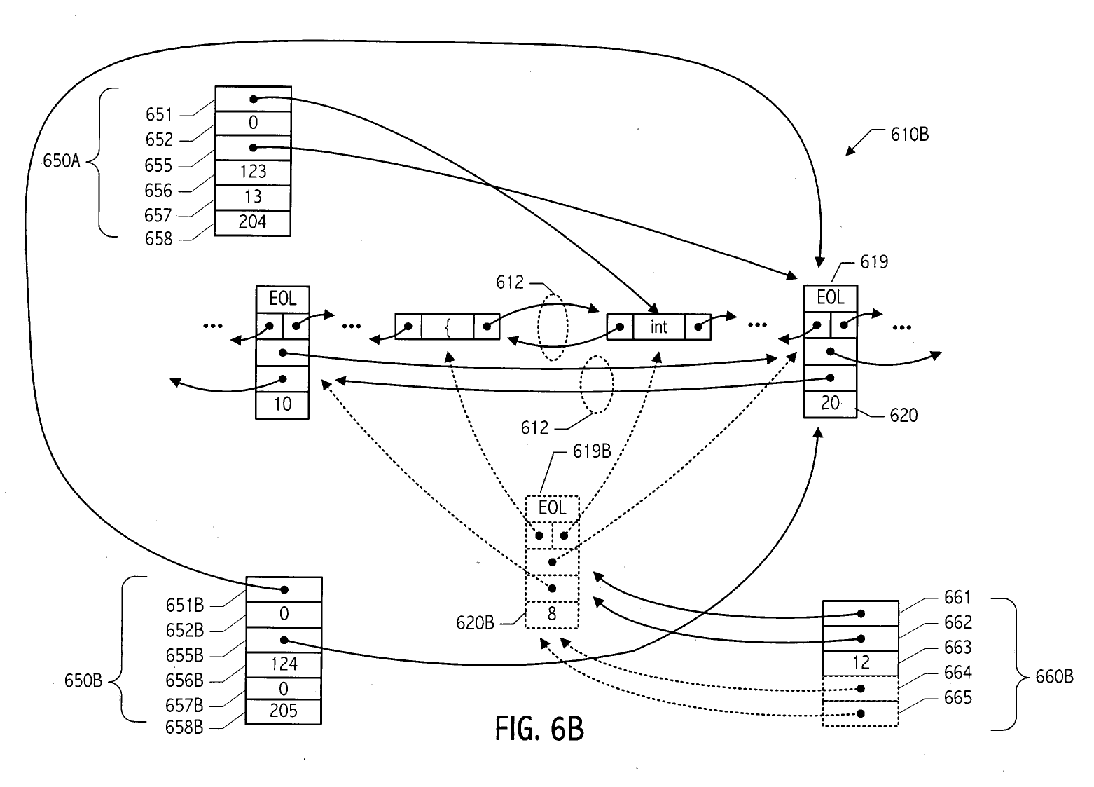

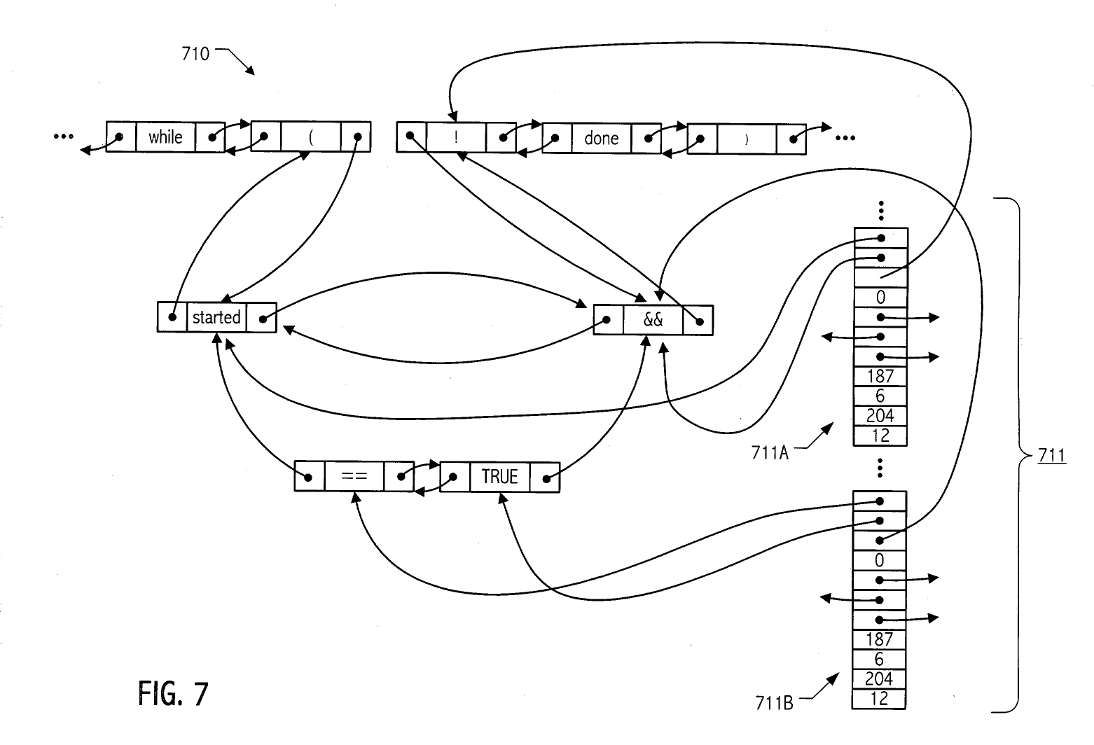

FIG. 7 represents a tokenized program representation that illustrates results of an insertion operation that is followed by a removal operation that targets a portion of the previously inserted code. A partial state 710 of the tokenized program representation and a illustrative state of undo-redo objects are depicted. In particular, ordered set 711 of undo-redo objects includes an undo-redo object 711A that identifies opposing ends of the inserted four node fragment, while undo-redo object 711B identifies an interior portion thereof that has been removed from the state 710 of the tokenized program representation by a subsequent removal operation. Undo-redo object 711A records other pre-insertion state information as described herein with respect to insertion operations. Similarly, undo-redo object 711B records other pre-excision state information as previously described herein with respect to removal operations. Although EOL tokens are omitted from the illustrated partial state 710 for simplicity, undo-redo objects 711A and 711B include EOL token pointers in accordance with the above-described insertion and removal operations. Use of such EOL token pointers in undo-redo objects will be better understood with reference to FIGS. 5A-5D and 6A-6B.

Of course, any of a variety of additional edit operations, including intervening edit operations, may correspond to other undo-redo objects (now shown) of the ordered set. In general, the ordered set can be represented in any of a variety of ways. One such representation is as a linked list of such undo-redo objects (links not shown) wherein a current point in the ordered set is maintained and execution of undo operations moves the current point back in the ordered set, while execution of redo operations move the current point forward in the ordered set.

In general, semantics of undo and redo operations are well understood in the art. Of course, a given implementation may seek to limit the amount of storage allocated to undo and redo support and, accordingly, may restrict the growth of the ordered set to a predetermined size. Nonetheless, the techniques described herein may be employed more generally in an unbounded ordered set of undo-redo objects and any particular limitation on sizing of such a structure may be selected based on constraints of a particular implementation or design.

Some embodiments in accordance with the present invention offer particularly efficient computation of, or access to, particulars for a tokenized program representation (e.g., 110) and an insertion point representation (e.g., 150). While not all features of the exemplary configurations(s) described above are necessarily included in every realization in accordance with the present invention, several observations are notable at least for an exemplary configuration that includes a superset of disclosed features. First, a line number for the current line containing the insertion point (see e.g., field 156), an insertion point offset into the current line (see e.g., field 157), a current line length (see e.g., field 120 of EOL token 119) and a total line count (see e.g., field 158) can all be retrieved in constant, i.e., O(1), time since each is maintained consistent with access (e.g., insertion and deletion) and repositioning operations. For some software engineering and/or editing tools efficient retrieval can be advantageous. In some variations that also provide character-coordinates, a character offset from beginning of buffer or stream and a total character count may also be provided and retrievable in constant, i.e., O (1), time since each is maintained consistent with access (e.g., insertion and deletion) and repositioning operations. Additionally, the first and last tokens of the current line can be determined in constant, i.e., O (1), time since an eol pointer (see e.g., field 155) that identifies a current line EOL token (see e.g., EOL token 119) is maintained and the current line EOL token itself includes a previousEOL pointer that identifies the preceding EOL token (e.g., EOL token 119A).

Repositioning the insertion point generally involves traversing the tokenized program representation forward or backward from a current insertion point. Some embodiments in accordance with the present invention offer particularly efficient computation of particulars for a repositioned insertion point. While not all features of the exemplary configuration(s) described above are necessarily included in every realization in accordance with the present invention, several observations are notable, at least for an exemplary configuration that includes a superset of disclosed features.

First, relative repositioning of the insertion point to a new position can involve scanning forward or backward from a current insertion point, a node at a time, updating cached insertion point information such as line offset (e.g., field 157) and, if a line boundary is crossed, current line eol pointer (e.g., field 155) and current line number (e.g., field 156). Each of these operations takes constant, i.e., O(1), time so incremental character position by character position repositioning of the insertion point still scales, at worst as O(N) in the size, N, of the move, not the size of the program or buffer content. Relative movement can be further optimized, however. In particular, repositioning the insertion point to some relative position, whether specified in terms of line and line offset (or in terms of character offset, if supported) can be performed with computation that scales as O(L)+O(T), where L is the number of lines (i.e., EOL tokens) traversed and T is the number of tokens in the target line. Accordingly, by exploiting the pointer chain that links successive EOL tokens, such a repositioning operation can be performed quite efficiently. Whether the desired location is in a particular line can be determined by examining the line length cached in the EOL token (e.g., in field 120 of EOL token 119).

Second, arbitrary repositioning can be similarly performed and optimized. For example, repositioning the insertion point to some arbitrary position, whether specified in terms of line and line offset (or in terms of character offset, if supported) can be performed with computation that scales as O(L)+O(T), where (as before) L is the number of lines (i.e., EOL tokens) traversed (e.g., from the beginning of buffer) and T is the number of tokens in the target line. Arbitrary repositioning can be further optimized by considering the option to start traversing from the beginning of buffer, end of the buffer, or current insertion point (e.g., a relative repositioning). In short, by comparing the target location with the beginning of the program (i.e., line 0), to the end of the buffer whose position corresponds to the last line and (optionally) to the current insertion point, an efficient traversal path (e.g., from beginning, end or “middle”) can be selected. In some cases it may take significantly less time to traverse the path so selected. Of course, starting positions other than, or in addition to, those described could be employed.

Finally, even relative repositioning can be further optimized, if desired, by selected an efficient traversal path. As before, by comparing a relatively-addressed target location with the beginning of the program (i.e., line 0), to the end of the buffer whose position corresponds to the last line, an alternate traversal path (e.g., from beginning or end) can be selected. In some cases it may take significantly less time to traverse the path so selected.

While the illustrations of FIGS. 3A-3D and 4A-4D focused on insertions that did not introduce additional lines (and associated EOL tokens) and deletions that did not remove lines (and associated EOL tokens), persons of ordinary skill in the art will recognize that the exemplary functional code (above) fully contemplates such situations. Accordingly, FIGS. 5A, 5B, 5C and 5D illustrate an insertion which introduces an additional line boundaries and associated EOL tokens. FIGS. 6A, 6B, 6C and 6D illustrate a deletion that removes a line boundary and associated EOL token.

FIG. 5A illustrates an initial partial state 510A of a tokenized program representation. For simplicity, only a partial state corresponding to a fragment,

. . . {int . . . ,

of the total program code is illustrated and the illustrated insertion adds a fragment that includes EOL tokens corresponding to additional newlines. Based on the example and other description herein, persons of ordinary skill in the art will appreciate handling of any insertion that includes a newline.

Insertion point representation 550 depicts an insertion point state corresponding to a position immediately preceding the “i” character in “int” as it exists prior to the operation of the illustrated insertion. As before, insertion point representation 550 includes a token-coordinates representation, i.e., pointer 551 identifies the corresponding node of the tokenized program representation and offset 552 identifies the offset (in this case, offset=0) thereinto. Line-coordinates are further represented in insertion point representation 550 using pointer 555 (which identifies EOL token 519) and an offset thereinto (see field 557, encoding an offset of 13 character positions into the line identified by pointer 555). Insertion point representation 550 caches a line number (e.g., line 123, see field 556) corresponding to the insertion point. EOL token 519 optionally encodes a line length (e.g., 20 character positions, see field 520) and insertion point representation 550 optionally caches a total line count (e.g., 204 total lines, see field 558).

Turning to FIG. 5B, we illustrate the result of an insertion into the tokenized program representation (pre-insertion state 510A) of fragment 514 including additional EOL tokens (e.g., EOL tokens 519A and 519B) corresponding to user edits of the program code. In the illustration of FIG. 5B, updates to bi-directional pointers 512A and 512B and to bi-directional EOL token pointers 512C and 512D effectuate the insertion into the tokenized program representation resulting in post-insertion state 510B. A post insertion state 550A of the insertion point is maintained in correspondence with the insertion. Based on the illustrated insertion point convention and the particular insertion illustrated, no update to token identifier (pointer 551) or offset thereinto (field 552) is necessary. However, current line number, line offset, total line count and certain EOL token fields are updated in accordance with the inserted fragment 514. In particular, line count (field 556) is updated to reflect that the current line containing the insertion point is now line 125 in the buffer, line offset (field 557) is updated to indicate that the insertion point now resides at character position 0 of the current line, and total line count (field 558) is updated to reflect a line count of 206. Field 520B of EOL token 519 and field 521 of EOL token 519A are similarly updated to reflect allocation of character positions to the respective lines.

As before, an undo-redo structure 511 is illustrated, which identifies (through respective pointers 561 and 562) opposing ends of the inserted fragment 514. Additional pointer fields (firstEOL 565 and lastEOL 564) identify respective first and last EOL tokens included in fragment 514 to facilitate later undo of the splice (see bi-directional EOL token pointers 512C and 512D) into the EOL token pointer chain of post-insertion state 510B. In addition, the undo-redo structure includes a stored insertion point representation 550B corresponding to the insertion point state and total line count state that existed prior to operation of the illustrated insertion. Token pointer 551B, in-token character offset field 552B, next EOL token pointer 555B, line number field 556B and in-line character offset field 557B, and total line count field 558B encode respective pre-insertion states.

Turning to FIG. 5C, we illustrate results of an undo operation that reverses the effect on the tokenized program representation of the previously executed insertion operation. As before, while the doubly-linked list state is restored, the previously inserted fragment 514 of tokens continues to be represented and identified by a corresponding undo-redo structure, namely undo-redo structure 511D. In particular, first and last tokens of previously inserted fragment 514 are identified by pointers 562 and 561, while first and last EOL tokens of the previously inserted fragment are identified by pointers 565 and 564. Since these identified tokens themselves maintain their identification of splice point nodes of in the tokenized program representation, subsequent redo of the undone insertion is facilitated. To effectuate insertion point restoration, the stored (pre-insertion) insertion point representation 550B is swapped for that represented as current insertion point state 550A (recall FIG. 5B). The resulting swapped states are illustrated in FIG. 5C. To effectuate efficient restoration of other aspects of the tokenized program representation state, pointers and fields grouped as 560B are employed. In particular, the stored (pre-insertion) state 563 of line length field (recall state 520A in FIG. 5A) is swapped for then current line length state 520B of EOL token 519. The result is illustrated in FIG. 5C. Use of first token and last token pointers 562 and 561 and of firstEOL and lastEOL pointer fields 565 and 564 are explained above. After completion of the undo operation, undo-redo structure 511D provides state information to support efficient redo.

Results of a subsequent redo are illustrated in FIG. 5D. Reinstatement of the token insertion into the tokenized program representation is effectuated by re-establishing the bi-directional pointer chains (both token chains and EOL token chains) through previously inserted (and previously-undone) fragment 514, resulting in post-redo state 510D. As detailed in the preceding illustrative code, undo-redo structure 511D state (see FIG. 5C) provides the reference chains that allow update of respective pointers of splice point nodes for efficient redo the previously undone insertion of fragment 514. After completion of the redo operation, undo-redo structure 511F continues to identify (through respective pointers 561, 562) opposing ends and (through respective pointers 564 and 565) rightmost and leftmost EOL tokens of the now re-inserted fragment 514. In this way, a subsequent undo may be efficiently supported.

As before, to effectuate insertion point restoration, the stored (post-insertion) insertion point representation 550D is swapped for that represented as current insertion point state 550C (recall FIG. 5C). The resulting swapped states are illustrated in FIG. 5D. To effectuate efficient restoration of other aspects of the tokenized program representation state, stored pointers and fields grouped as 560D are employed. In particular, the stored (post-insertion) state 563 of line length field (recall state 520B in FIG. 5B) is swapped for then current line length state 520C of EOL token 519. The result is illustrated in FIG. 5D. Use of first token and last token pointers 562 and 561 and of firstEOL and lastEOL pointer fields 565 and 564 are explained above. After completion of the redo operation, undo-redo structure 511F provides state information to support efficient undo. As before, states illustrated in FIGS. 5B and 5D are equivalent and alternating undo and redo operation sequences of indefinite length may be performed while preserving desired behavior and state.

FIG. 6A illustrates an initial partial state 610A of a tokenized program representation. Insertion point representation 650 depicts an insertion point state corresponding to a position immediately preceding the “i” character in “int” as it exists prior to the operation of the illustrated removal. In particular, insertion point representation 650 includes a token-coordinates representation, i.e., pointer 651 identifies the corresponding node of the tokenized program representation and offset 652 identifies the offset (in this case, offset=0) thereinto. Line coordinates are represented in insertion point representation 650 using pointer 655 (which identifies EOL token 619) and an offset thereinto (see field 657, encoding an offset of 0 character positions into the line identified by pointer 655). EOL token 619 encodes a line length (e.g., 12 character positions, see field 620). As before, insertion point representation 650 optionally caches a line number (e.g., line 124, see field 656) corresponding to the insertion point and a total line count (e.g., 205 total lines, see field 658).

FIG. 6B then illustrates the result of a removal from the tokenized program representation (i.e., from pre-removal state 610A) of a newline (EOL token 619B) corresponding to user edits of the program code. In the illustration of FIG. 6B, bi-directional pointers 612 are updated to bridge excised EOL token 619B. A post removal state 650B of the insertion point is maintained in correspondence with the removal. Based on the illustrated insertion point convention and the particular removal illustrated, no update to token identifier or offset thereinto is necessary. However, current line number, line offset, total line count and an EOL token field are updated in accordance with the removal of EOL token 619B. In particular, line count (field 656) is updated to reflect that the current line containing the insertion point is now line 123 in the buffer and line offset (field 657) is updated to indicate that the insertion point now resides at character position 13 of the current line (now rejoined). Field 620 of EOL token 619 is similarly updated to reflect allocation of character positions to the current line.

As before, an undo-redo structure is illustrated, which identifies (through respective pointers 661 and 662) opposing ends of the excised token 619B. Optional pointer fields (firstEOL 665 and lastEOL 664) identify respective first and last EOL tokens (i.e., excised token 619B) of the excised fragment to facilitate later undo of the excision. Also as before, the undo-redo structure includes a stored insertion point representation 650B corresponding to the insertion point state and total line count state that existed prior to operation of the illustrated insertion. Token pointer 651B, in-token character offset field 652B, next EOL token pointer 655B, line number field 656B and in-line character offset field 657B, and total line count field 658B encode respective pre-insertion states. Undo and redo operations are comparable to those previously illustrated and some illustrative realizations will be understood with reference to the above-described code.

Exemplary Editor Implementation

In general, techniques of the present invention may be implemented using a variety of editor implementations. Nonetheless, for purposes of illustration, the description of exemplary editor implementations in U.S. Pat. No. 5,737,608, entitled “PER-KEYSTROKE INCREMENTAL LEXING USING A CONVENTIONAL BATCH LEXER” is incorporated herein by reference. In particular, while the preceding code implements token operations, persons of ordinary skill in the art will recognize that editor and/or programming tools implementations may often include operations that operate at a level of abstraction that corresponds to character manipulations. Such character-oriented manipulations typically affect the state of an underlying token-oriented representation and such state changes can be effectuated using token operations such as the insertion and removal operations described herein. Of course, alternate and/or additional operations may be appropriate in other implementations. To generate sequences of token-oriented operations that correspond to character manipulations, incremental lexing techniques described in the '608 patent may be employed in some realizations.

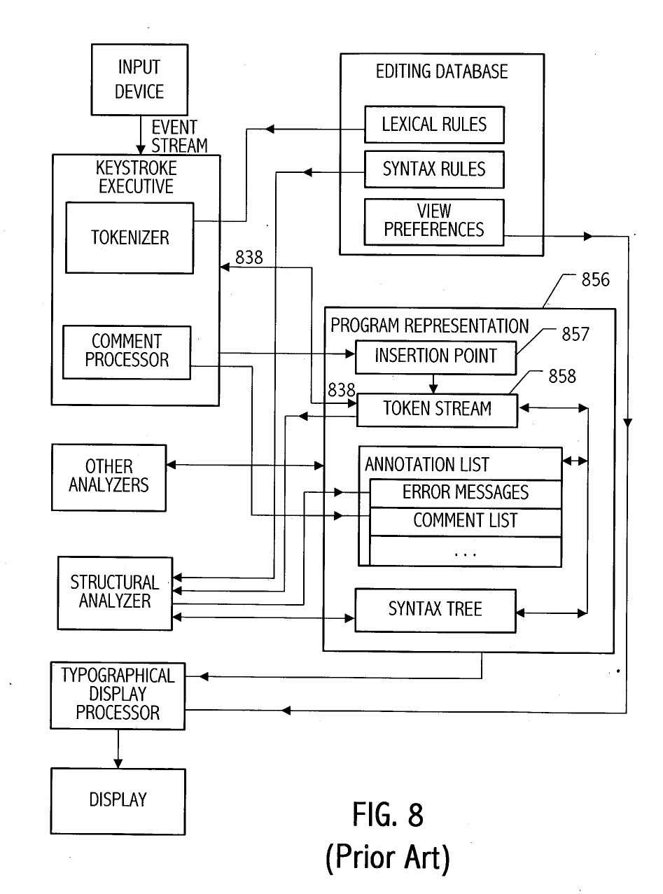

FIG. 8 depicts interactions between various functional components of an exemplary editor implementation patterned on that described in greater detail in the '608 patent. In particular, techniques of the present invention are employed to implement program representation 856, and particularly token stream representation 858 and insertion point representation 857, to support efficient edit and repositioning operations. By implementing operations 838, including insert and remove operations, on token stream representation 858 as described above, such efficiency is provided. Based on the description herein, including the above-incorporated description, persons of ordinary skill in the art will appreciate a variety of editor implementations that may benefit from features and techniques of the present invention.

While the invention has been described with reference to various embodiments, it will be understood that these embodiments are illustrative and that the scope of the invention is not limited to them. Many variations, modifications, additions, and improvements are possible. In particular, a wide variety of lexical contexts may be supported. For example, while a lexical context typical of program code has been illustrated, other lexical contexts such as those appropriate to markup languages, comments, even multimedia content may be supported. Similarly, although much of the description has focused on functionality of an editor, the techniques described herein may apply equally to other interactive or even batch oriented tools. While lexical analysis of textual content has been presumed in many illustrations, persons of ordinary skill in the art will recognize that the techniques described herein also apply to structure-oriented editors and to implementations that provide syntactic, as well as lexical, analysis of content.

More generally, plural instances may be provided for components described herein as a single instance. Boundaries between various components, operations and data stores are somewhat arbitrary, and particular operations are illustrated in the context of specific illustrative configurations. Other allocations of functionality are envisioned. Structures and functionality presented as discrete in the exemplary configurations may be implemented as a combined structure or component. These and other variations, modifications, additions, and improvements may fall within the scope of the invention as defined in the claims that follow.

What is claimed is:

1. A method of providing undo operation support in an edit buffer represented as a ordered set of lexical tokens, the method comprising:
maintaining, in correspondence with operations that modify contents of the edit buffer, an ordered set of undo objects that identify respective subsets of the lexical tokens corresponding to content removed by respective ones of the modifying operations; and
maintaining in correspondence with the undo objects, respective encodings of pre-modification states including state for at least some pre-modification line demarcations.

2. The method of claim 1, wherein the pre-modification line demarcation state includes one or more of:
a line-coordinates representation of insertion point;
a total line count;
a character count in current line;
identification of at least one line demarcation token in the removed subset of tokens; and
identification of first and last line demarcation tokens in the removed subset of tokens.

3. The method of claim 1,
wherein forward and backward pointers traverse the ordered set of lexical tokens encoded as a list; and
wherein additional line-related pointers are associated with the line demarcations, the line-related pointers identifying respective previous and next line demarcations of the list.

4. The method of claim 1,
wherein the maintained pre-modification states include pre-modification state of an insertion point into the edit buffer.

5. The method of claim 1, further comprising:
storing the encodings of pre-modification states in respective ones of the undo objects.

6. The method of claim 1,
wherein pre-modification states encode both a token-coordinates representation of insertion point state and a line-coordinates representation of insertion point state.

7. The method of claim 1,
wherein the line-coordinates representation encodes both a line and a line offset therein corresponding to the insertion point.

8. The method of claim 1,
wherein the line-coordinates representation encodes a reference to a line demarcation token corresponding to the insertion point.

9. The method of claim 1,
wherein the line demarcations are embodied as end-of-line (EOL) tokens.

10. The method of claim 6,
wherein the line-coordinates representation identifies both an end-of-line (EOL) token and a character-offset, zero or more, thereinto, which together correspond to pre-modification insertion point state.

11. The method of claim 1, further comprising:
restoring, in correspondence with an undo operation, a corresponding removed one of the lexical token subsets;
restoring, in correspondence with the undo operation, the insertion point using a corresponding one of the pre-modification insertion point state encodings.

12. The method of claim 11,
wherein the restoring includes swapping a then current insertion point state with a pre-modification insertion point state encoding that corresponds to the removed one of the lexical token subsets.

13. The method of claim 11, further comprising:
subsequent to completion of the undo operation and in correspondence with a redo operation, reinstating the undone removal and swapping a then current insertion point state with an insertion point state encoding that corresponds to the reinstated removal.

14. The method of claim 1,
wherein the modifying operations include remove-type operations.

15. The method of claim 1,
wherein the modifying operations include insert-type operations.

16. The method of claim 1, further comprising:
restoring, coincident with an undo directive, the doubly-linked list of lexical tokens to a state that existed prior to prior to execution of a particular remove-type operation at least in part by reintroducing thereinto a fragment identified by a corresponding one of the undo objects; and
maintaining in connection with a redo object, identification of at least the opposing end nodes of the reintroduced fragment.

17. The method of claim 1, further comprising:
maintaining in connection with the redo object, identification of one or more of a first line demarcation node and a last line demarcation node of the reintroduced fragment.

18. A software engineering tool comprising:
a representation of program code encoded in a computer readable medium as a set of nodes, each node corresponding to a respective token recognized in accordance with an operative set of lexical rules;
functional encodings of edit methods executable to operate on the set of nodes; and
an undo-redo manager that maintains an ordered set of undo-redo objects in correspondence with operation of the edit methods, undo-type ones of the undo-redo objects including respective encodings of at least some line demarcation states prior to operation of the respective edit methods.

19. The software engineering tool of claim 18,
wherein at least some of the nodes correspond to line demarcations; and
wherein line-related pointers are associated with the line demarcations, the line-related pointers identifying respective previous and next line demarcation nodes of the program code representation.

20. The software engineering tool of claim 18,
wherein the undo-redo objects further include respective encodings of pre-modification states of an insertion point into the program code representation.

21. The software engineering tool of claim 18,
wherein redo-type ones of the undo-redo objects include respective encodings of at least some line demarcation states prior to operation of the respective edit methods.

22. The software engineering tool of claim 18,
wherein the undo-redo manager further maintains the ordered set of undo-redo objects in correspondence with operation of undo and redo directives, wherein the maintaining includes swapping a pre-directive insertion point state with an insertion point state encoding that corresponds to respectively undone or redone edit operation.

23. The software engineering tool of claim 18, further comprising:
a functional encoding of an undo directive that reverses effects of a previously executed edit operation on state of the list.

24. The software engineering tool of claim 18,
a functional encoding of a redo directive that reinstates effects of a previously executed edit method on state of the list.

25. A software engineering tool encoded in one or more computer readable media as instructions executable to represent program code as lexical tokens and to maintain, consistent with an operation that either removes one or more line demarcation tokens from the representation or introduces one or more line demarcation tokens into the representation, an undo object that encodes a pre-modification state that identifies at least some of the removed or introduced line demarcation tokens.

26. The software engineering tool of claim 25,
wherein the pre-modification state further encodes both a token coordinates representation and a line coordinates representation of the insertion point.

27. The software engineering tool of claim 26,
wherein the line coordinates representation identifies both a particular one of the lexical tokens and a character offset into the corresponding line.

28. The software engineering tool of claim 26, configured as one or more of:
an editor;
a source level debugger;
a class viewer;
a profiler;
a style checker,
a compiler or interpreter; and
an integrated development environment.

29. The software engineering tool of claim 25,
wherein the one or more computer readable media are selected from the set of a disk, tape or other magnetic, optical, or electronic storage medium and a network, wireline, wireless or other communications medium.

30. One or more computer readable media encoding a data structure that represents contents of an edit buffer as a sequence of lexical tokens, the encoded data structure comprising:
a doubly linked list of nodes;
token representations each corresponding to at least one respective node of the list, wherein at least some of the token representations correspond to line demarcations; and
an ordered representation of undo objects that identify (i) respective sublists of one or more lexical tokens introduced into or removed by a list modifying operation, (ii) a pre-modification state of an insertion point and (iii) pre-modification state of at least some line demarcations.

31. The encoded data structure of claim 30,
wherein the identification of pre-modification line demarcation state facilitates reversal of introductions and removals, including update of insertion point line-coordinates state, in response to respective undo directives with a computational burden that is independent of size of the edit buffer and independent of size of the introduction or removal.

32. The encoded data structure of claim 30, embodied as a software object that defines at least one of the list modifying operations.

33. The encoded data structure of claim 30,
wherein the one or more computer readable media are selected from the set of a disk, tape or other magnetic, optical, or electronic storage medium and a network, wireline, wireless or other communications medium.

34. An apparatus comprising:
storage for a computer readable encoding of an edit buffer represented as a sequence of lexical tokens; and
means for maintaining an edit-operation-ordered representation of undo objects that each include respective encodings of both pre-modification line demarcation state and pre-modification insertion point state.

35. The apparatus of claim 34, further comprising:
means for reversing a particular execution of one of the list modifying edit operations using the pre-modification line demarcation and insertion point states.

36. The apparatus of claim 35, further comprising:
means for supporting reinstatement of the reversed edit operation including means for swapping a then current insertion point state with an insertion point state encoding that corresponds to insertion point state prior to the reversed edit operation.
